(19) United States
(12) Patent Application Publication
(10) Pub. No.: US 2014/0155675 A1
(43) Pub. Date: Jun. 5, 2014

(54) ROBUST MULTILAYER ENCAPSULATION AND STORAGE OF ATOMIC WASTE

(71) Applicant: Edward Murphy, Naples, FL (US)

(72) Inventor: Edward Murphy, Naples, FL (US)

(21) Appl. No.: 14/119,870

(22) PCT Filed: May 29, 2011
(86) PCT No.: PCT/US2012/039854

§ 371 Date: Feb. 11, 2014

Related U.S. Application Data
(60) Provisional application No. 61/519,642, filed on May 26, 2011.

(51) Int. Cl. G21F 9/00; G21F 5/005; G21F 9/16

(52) U.S. Cl. CPC G21F 9/008; G21F 9/16; G21F 5/005
USPC 588/16; 250/506.1; 65/60.1

(57) ABSTRACT

The invention includes a radioactive waste containment system for containing a radioactive waste material. The radioactive waste containment system includes a radioactive waste containment system outermost exterior containment layer comprised of an exterior containment layer glass material having an exterior containment layer property. The radioactive waste containment system includes a radioactive waste containment system adjacent interior containment layer, the adjacent interior containment layer comprised of an adjacent interior containment layer glass material having an adjacent interior containment layer property, the radioactive waste containment system adjacent interior containment layer is fused with the radioactive waste containment system outermost exterior containment layer with the properties not equal wherein the fused adjacent interior containment layer and the radioactive waste containment system outermost exterior containment layer are in compression.

This application claims the benefit of, and incorporates by reference, U.S. Provisional Patent Application No. 61/519,642 filed on May 26, 2011.

### FIELD OF THE INVENTION

The invention pertains to the disposal and storage of Radioactive Atomic Waste.

### SUMMARY OF THE INVENTION

In an embodiment the invention includes a radioactive waste containment system for containing a radioactive waste material. The radioactive waste containment system includes a radioactive waste containment system outermost exterior containment layer comprised of an exterior containment layer glass material having an exterior containment layer property λE. The radioactive waste containment system includes a radioactive waste containment system adjacent interior containment layer, the adjacent interior containment layer comprised of an adjacent interior containment layer glass material having an adjacent interior containment layer property λ, the radioactive waste containment system adjacent interior containment layer fused with the radioactive waste containment system outermost exterior containment layer with λE≠λ wherein the fused adjacent interior containment layer and the radioactive waste containment system outermost exterior containment layer are in compression. Preferably the fused in compression adjacent interior containment layer and outermost exterior containment layer provide for containment of a radioactive waste material. Preferably the exterior containment layer property λE is a Coefficient of Thermal Expansion (CTE) of the exterior containment layer glass material, and the adjacent interior containment layer property λ is a Coefficient of Thermal Expansion (CTE) of the adjacent interior containment layer glass material with λE<λ. Preferably the radioactive waste containment system includes an innermost waste adjacent interior containment layer, the radioactive waste containment system innermost waste adjacent interior containment layer for containment of a radioactive waste material while the radioactive waste material is melted at a glass melting temperature. Preferably the radioactive waste containment system includes a containment system top lid, the containment system top lid comprised of a lid exterior containment layer and a lid adjacent interior containment layer. Preferably the radioactive waste containment system outermost exterior containment layer includes a vertically oriented side wall, wherein the lid exterior containment layer is sealed to the vertically oriented side wall with a glass material.

In an embodiment the invention includes a method of making a radioactive waste containment system for containing a radioactive waste material. The method includes providing an adjacent interior containment layer glass material having an adjacent interior containment layer property λ. The method includes providing an outermost exterior containment layer glass material having an exterior containment layer property λE with λE≠λ. The method includes orienting the outermost exterior containment layer glass material relatively external of the adjacent interior containment layer glass material to provide for containment of a radioactive waste isolated from a surrounding exterior environment. Preferably the exterior containment layer property λE is a Coefficient of Thermal Expansion (CTE) of the exterior containment layer glass material, and the adjacent interior containment layer property λ is a Coefficient of Thermal Expansion (CTE) of the adjacent interior containment layer glass material with λE<λ. Preferably the exterior containment layer glass material and the adjacent interior containment layer glass material are fused together to provide a radioactive waste containment system outermost exterior containment layer and an adjacent interior containment layer, with the radioactive waste containment system outermost exterior containment layer and the adjacent interior containment layer in compression. Preferably the method includes providing an innermost waste adjacent interior containment layer. Preferably the method includes providing a melted radioactive waste glass material at a radioactive waste glass material melting temperature, and disposing the melted radioactive waste glass material adjacent the innermost waste adjacent interior containment layer. Preferably the method includes providing a containment system top lid, the containment system top lid comprised of a lid exterior containment layer and a lid adjacent interior containment layer. Preferably the outermost exterior containment layer includes a vertically oriented side wall, and the containment system top lid is disposed on top of the outermost exterior containment layer vertically oriented side wall. Preferably the method includes sealing the lid exterior containment layer to the outermost exterior containment layer vertically oriented side wall with a glass material.

In an embodiment the invention includes a method of containing a radioactive waste. The method includes providing a waste material. The method includes providing a interior containment layer glass material having an interior containment layer Coefficient of Thermal Expansion (CTE) property λ. The method includes providing an exterior containment layer glass material having an exterior containment layer property Coefficient of Thermal Expansion (CTE) property λE with λE<λ1. The method includes orienting the exterior containment layer glass material relatively external of the interior containment layer glass material to provide an in compression interior containment layer and an in compression exterior containment layer wherein the waste material is isolated from a surrounding exterior environment by the in compression interior containment layer and the in compression exterior containment layer with the radioactive waste material proximate the in compression interior containment layer. Preferably the exterior containment layer glass material and the interior containment layer glass material are fused together. Preferably the waste material is disposed in contact with an innermost waste adjacent interior containment layer. Preferably the method includes providing a melted radioactive waste glass material at a radioactive waste glass material melting temperature, and disposing the melted radioactive waste glass material adjacent the innermost waste adjacent interior containment layer. Preferably the method includes providing a containment system top lid, the containment system top lid comprised of a lid exterior containment layer and a lid adjacent interior containment layer. Preferably the exterior containment layer includes a vertically oriented side wall, and the containment system top lid is disposed on top of the outermost exterior containment layer vertically oriented side wall. Preferably the method includes sealing the lid exterior containment layer to the outermost exterior containment layer vertically oriented side wall with a glass material.

In an embodiment the invention includes a radioactive waste containment system, the radioactive waste containment system including a means for containing a radioactive waste material. Preferably the means for containing a radioactive waste material includes at least a first glass material layer in compression.

In embodiments the invention includes waste containment system as disclosed herein.

In embodiments the invention includes methods of containing radioactive waste as disclosed herein.

This invention utilizes multilayer enclosures for containment and storage of atomic nuclear radioactive waste. In preferred embodiments, the enclosure containment system has at least two layers of property differentiated glass materials, preferably fused glass and/or glass ceramic materials.

It is to be understood that both the foregoing general description and the following detailed description are exemplary of the invention, and are intended to provide an overview or framework for understanding the nature and character of the invention as it is claimed. The accompanying tables and drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIG. 1 shows a sectional view of an outermost exterior containment layer one as a rectangle shaped glass material container enclosure containment layer without the lid.

FIG. 2 shows a sectional view of a rectangle shaped mold used to form glass material adjacent interior containment layer two or layer three.

FIG. 3 shows a sectional view of a two layer lid nearly resting on a two layer rectangle containment system enclosure using the preferred all glass material layers fused together embodiments.

FIG. 4 shows a sectional view of a two layer lid resting on a two layer rectangular containment system enclosure with a hot glass level measurement system.

FIG. 5 shows a sectional view of a containment system rectangular enclosure with an outermost exterior glass material containment layer L1 and an innermost glass material adjacent interior containment layer L2 inside of a heated furnace melting the radioactive waste into a vitrified glass matrix (L3) using the preferred all layers fused together embodiments.

FIG. 6 shows a sectional view of a containment system with the sealing of the lid onto the three glass materials layer enclosure (L1, L2, L3) using the preferred all glass materials layers fused together embodiments.

FIG. 7 shows a block diagram of the hot glass laser level measurements detectors, electronics and position sensor output.

FIG. 8 shows a sectional view of a containment system with the final sealing of the outside of the outermost exterior glass material containment layer L1 indentation at the horizontal sealing plane of the lid using the preferred all layers glass materials fused together embodiments.

FIG. 9 shows a view of a cylindrically shaped two layer enclosure for preferred embodiments B1 of the containment system.

FIG. 10 shows a sectional view of a cylindrically shaped three layer lid nearly resting on containment system cylindrical enclosure for preferred embodiment B1 using the preferred all layers fused together embodiments.

FIG. 11 shows a sectional view of the containment system as a rectangle shaped container with the final sealing of the outermost exterior glass material containment layer L1 indentation at the horizontal sealing plane of the lid.

FIG. 12 shows a sectional view of a cylindrically shaped containment system for preferred embodiment B1 where the three layer lid is fabricated in place using molten frit in an embodiment.

FIG. 13 shows a sectional view of a cylindrically shaped containment system for preferred embodiment B1 where the three layer lid is fabricated in place using flame hydrolysis of soot to molten glass in an embodiment of this invention

FIG. 14 shows a sectional view of a containment system with an outermost exterior containment layer and its adjacent interior containment layer inside of a heated furnace with the melting of the radioactive waste into a vitrified glass matrix inside an innermost interior containment layer comprised of a high melting temperature (≧1300° C.) glass material which is not fused to the outermost exterior containment layer.

FIG. 15 shows a sectional view of a closed containment system with rectangle shaped glass material containment layers with a glass material layer as a not fused layer of the preferred one layer not fused embodiments.

FIG. 16 shows a sectional view of a outermost exterior containment layer and adjacent interior containment layer rectangular enclosure inside of a heated furnace melting the radioactive waste into a vitrified radioactive waste glass matrix.

FIG. 17 shows a sectional view of a closed containment system with a glass material layer as a not fused layer of the preferred one layer not fused embodiments.

FIG. 18 shows a containment system with a glass material layer as a not fused layer and includes a layer of metal as a mold for the fabrication molded layers.

FIG. 19 shows a sectional view of three layers of a containment system.

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended tables and drawings.

Reference will now be made in detail to the present preferred embodiments of the invention, examples of which are illustrated in the accompanying drawings.

In an embodiment the invention includes multilayer enclosures for containment and storage of atomic nuclear radioactive waste. In preferred embodiments, the enclosure containment system has at least two layers of property differentiated glass materials, preferably fused glass and/or glass ceramic materials.

In other preferred embodiments, the containment system enclosure has from two to six layers of different property glass materials.

In an embodiment the invention includes a radioactive waste containment system for containing a radioactive waste material. The radioactive waste containment system includes a radioactive waste containment system outermost exterior containment layer comprised of an exterior containment layer glass material having an exterior containment layer property λE. The radioactive waste containment system includes a radioactive waste containment system adjacent interior containment layer, the adjacent interior containment layer comprised of an adjacent interior containment layer glass material having an adjacent interior containment layer property λ, the radioactive waste containment system adjacent interior containment layer fused with the radioactive waste containment system outermost exterior containment layer with λE≠λ wherein the fused adjacent interior containment layer and the radioactive waste containment system outermost exterior containment layer are in compression. Preferably the fused in compression adjacent interior containment layer and outermost exterior containment layer provide for containment of a radioactive waste material. Preferably the exterior containment layer property λE is a Coefficient of Thermal Expansion (CTE) of the exterior containment layer glass material, and the adjacent interior containment layer property λ is a Coefficient of Thermal Expansion (CTE) of the adjacent interior containment layer glass material with λE<λ. Preferably the radioactive waste containment system includes an innermost waste adjacent interior containment layer, the radioactive waste containment system innermost waste adjacent interior containment layer for containment of a radioactive waste material while the radioactive waste material is melted at a glass melting temperature. Preferably the radioactive waste containment system includes a containment system top lid, the containment system top lid comprised of a lid exterior containment layer and a lid adjacent interior containment layer. Preferably the radioactive waste containment system outermost exterior containment layer includes a vertically oriented side wall, wherein the lid exterior containment layer is sealed to the vertically oriented side wall with a glass material.

In an embodiment the invention includes a method of making a radioactive waste containment system for containing a radioactive waste material. The method includes providing an adjacent interior containment layer glass material having an adjacent interior containment layer property λ. The method includes providing an outermost exterior containment layer glass material having an exterior containment layer property λE with λE≠λ. The method includes orienting the outermost exterior containment layer glass material relatively external of the adjacent interior containment layer glass material to provide for containment of a radioactive waste isolated from a surrounding exterior environment. Preferably the exterior containment layer property λE is a Coefficient of Thermal Expansion (CTE) of the exterior containment layer glass material, and the adjacent interior containment layer property λ is a Coefficient of Thermal Expansion (CTE) of the adjacent interior containment layer glass material with λE<λ. Preferably the exterior containment layer glass material and the adjacent interior containment layer glass material are fused together to provide a radioactive waste containment system outermost exterior containment layer and an adjacent interior containment layer, with the radioactive waste containment system outermost exterior containment layer and the adjacent interior containment layer in compression. Preferably the method includes providing an innermost waste adjacent interior containment layer. Preferably the method includes providing a melted radioactive waste glass material at a radioactive waste glass material melting temperature, and disposing the melted radioactive waste glass material adjacent the innermost waste adjacent interior containment layer. Preferably the method includes providing a containment system top lid, the containment system top lid comprised of a lid exterior containment layer and a lid adjacent interior containment layer. Preferably the outermost exterior containment layer includes a vertically oriented side wall, and the containment system top lid is disposed on top of the outermost exterior containment layer vertically oriented side wall. Preferably the method includes sealing the lid exterior containment layer to the outermost exterior containment layer vertically oriented side wall with a glass material.

In an embodiment the invention includes a method of containing a radioactive waste. The method includes providing a waste material. The method includes providing a interior containment layer glass material having an interior containment layer Coefficient of Thermal Expansion (CTE) property λ. The method includes providing an exterior containment layer glass material having an exterior containment layer property Coefficient of Thermal Expansion (CTE) property λE with λE<λ1. The method includes orienting the exterior containment layer glass material relatively external of the interior containment layer glass material to provide an in compression interior containment layer and an in compression exterior containment layer wherein the waste material is isolated from a surrounding exterior environment by the in compression interior containment layer and the in compression exterior containment layer with the radioactive waste material proximate the in compression interior containment layer. Preferably the exterior containment layer glass material and the interior containment layer glass material are fused together. Preferably the waste material is disposed in contact with an innermost waste adjacent interior containment layer. Preferably the method includes providing a melted radioactive waste glass material at a radioactive waste glass material melting temperature, and disposing the melted radioactive waste glass material adjacent the innermost waste adjacent interior containment layer. Preferably the method includes providing a containment system top lid, the containment system top lid comprised of a lid exterior containment layer and a lid adjacent interior containment layer. Preferably the exterior containment layer includes a vertically oriented side wall, and the containment system top lid is disposed on top of the outermost exterior containment layer vertically oriented side wall. Preferably the method includes sealing the lid exterior containment layer to the outermost exterior containment layer vertically oriented side wall with a glass material.

In an embodiment the invention includes a radioactive waste containment system, the radioactive waste containment system including a means for containing a radioactive waste material. Preferably the means for containing a radioactive waste material includes at least a first glass material layer in compression.

In more than one preferred embodiment, all glass material layers are fused together. In more than one preferred embodiment, at least one layer is not fused. Different glass materials and process steps are used to fabricate the multiple layers and such embodiments include embodiments A1, A2, A3, A4, A5, A6, A7, A8, A9, A10, B1, B2, C1 and C2. Table 1 shows the preferred glass materials, which includes glasses and glass ceramics, for outermost exterior containment layer one (L1) of the enclosure containment system for embodiments A1, A2, A3, A4, A5, A6, A7, A8, A9, A10, B1, B2, C1 and C2. The glass materials (glasses and glass ceramics) in Table 1 have preferred glass material exterior containment layer properties of Coefficient of Thermal Expansion (CTE) properties (λE) from 0.05 ppm/° K to 5.7 ppm/° K at 560° K. These glass materials with such Coefficient of Thermal Expansion (CTE) properties (λE) are preferred to provide relatively low CTE to build up a compressive layer relative to the adjacent interior layer two materials. The thermal and mechanical properties (λE) of these glass materials are important at 560° K because this is the approximate in use steady state storage temperature of the anticipated High Level Waste (HLW) radioactive waste material due to its radioactive nature. The glass materials in Table 1 have a high melting temperature (≧1300° C.), low resistance to thermal shock and excellent chemical durability. Table 2 shows the most preferred glass materials (glasses and glass ceramics) for the adjacent interior containment layer two of the enclosure containment system for the preferred Embodiments A1, A2, A3, A4, A5, A6, A7, A8, A9, A10, B1, B2, C1 and C2. The materials (glasses and glass ceramics) in Table 2 have a glass material property CTE from 0.32 ppm/° K to 8.9 ppm/° K at 560° K. These glass materials also have a low resistance to thermal shock, except the Soda Lime Glass and the Special Soda Lime Glass, and widely varying melting temperatures and glass material softening temperatures. The melting temperature for these glass materials is the temperature point in the Materials Viscosity Temperature Curve at 100 P (Poise) where the material is liquid. The Softening temperature for these glass materials is the temperature point in the materials Viscosity Temperature Curve at 10,000 P (Poise) where the material can maintain it shape for a limited time. Table 3.1 and Table 3.2 shows the most preferred glass material or metal materials for the next adjacent interior containment layer three of the enclosure containment system for the preferred Embodiments A1, A2, A3, A4, A5, A6, A7, A8, A9, A10, B1, B2, C1 and C2. Table 3.1 shows the most preferred glass materials for the preferred layers fused together embodiments where the next adjacent interior containment layer three is attached to adjacent interior containment layer two. The glass materials in Table 3.1 have a glass material property CTE from 2.0 ppm/° K to 8.9 ppm/° K at 560° K and a melting temperature ≧1050 C.°. Table 3.2 shows the most preferred glass materials and metal materials for the preferred one layer not fused embodiments where next interior layer three is not attached to interior layer two. The materials in Table 3.2 have melting temperature ≧1150 C ° and a wide range of material properties including Young's Modulus and Modulus of Rupture.

Table 4 shows the match up of the outermost exterior containment layer one and adjacent interior containment layer two glass materials referred to as preferred embodiments A1, A2, A3, A4, A5, A6, A7, A8, A9 & A10. In these preferred embodiments, the outermost exterior containment layer one material is made of a high temperature glass material with a low to medium CTE property. These glass materials have a high melting temperature ≧1300 C.° and for preferred Embodiments A1, A2, A3, A4, A5, A6, A7, A8A9 &A10 would be Fused Silica Glass, Ultra low expansion glass, Borosilicate glass or Medium Expansion Glass Ceramic. The outermost exterior containment layer one material is preferably formed first and then the adjacent interior containment layer two glass material would be formed and melted to the outermost exterior containment layer one glass material. Except for the preferred embodiments, A10 in Table 4 the Softening temperature of the outermost exterior containment layer one materials is at least 85 C.° higher than the melting temperature of the adjacent interior containment layer two glass materials as shown in Table 4. This is preferred so that the outermost exterior containment layer one glass material holds its shape and integrity during the heating and attachment of the subsequent interior containment layers. The containment system outer enclosure would not yet include the lid (the top of the containment system outer enclosure).

The adjacent interior containment layer two material abuts the adjacent exterior containment layer of the enclosure and is either formed inside the adjacent exterior containment layer outer enclosure or is prefabricated to fit inside the adjacent exterior containment layer outer enclosure without the lid. The preferred glass materials for adjacent interior containment layer two in preferred Embodiments A1, A2, A3, A4, A5, A6, A7, A8, and A9 &A10 are shown in Table 4. If the second layer or enclosure is formed inside the outer enclosure, a mold is used to contain the second layer. In the preferred Embodiments A1, A2, A3, A4, A5, A6, A7, A8 and A9 the interior containment layer two is fabricated separately from the outermost exterior containment layer and then is placed inside the outermost exterior containment layer with a predetermined predefined space (or void) so that molten material of the same composition of glass material may be melted, disposed in and formed between the adjacent interior layer and all the contact surfaces of the adjacent exterior layer. It is preferred that the adjacent interior glass layer is attached to the exterior containment layer with near defect free glass that is thermally melt wetted such that the adjacent layer has a melted virgin glass surface in contact and fused to the abutting adjacent layer. This hot glass material attachment will result in an open two containment layer enclosure that is in compression resulting in a very high strength containment system vessel. Near defect, free glass preferably means glass that have a low level of measurable defects that is fabricated in the optical glass industry for optical applications with few defects (minimal gaseous or solid inclusions, foreign material or particle defects) in its glass surface or glass body. The preferred defect free glass quality level for the fused material is ≧2.0 mm² total inclusion cross section in 100 cm³ of material when the maximum size is ≧0.1 mm. In addition, the glass surfaces to be fused together are preferably free of any visible defect (gaseous or solid inclusions, foreign material or particles). The glass defects are preferably measured by optical techniques for measuring defects in glass materials. The adjacent second layer is thick enough and properly cooled during the attachment to the adjacent first layer so that it does not totally melt but can slightly deform as long as the previously described wetting of the first and second layers occurs. In the preferred one layer not fused embodiments the two layer enclosure will be sealed with its top lid resulting in a strong, water resistant enclosure for the subsequent interior layers. In embodiments of this invention, a two layer open containment system vessel is very slowly and uniformly cooled (also called annealed) to ambient atmospheric temperature, so that a minimal but predetermined defined stress is set up. In most embodiments of this invention the two layer open enclosure of the containment system is inspected for uniform compression and the lid is fabricated and tested on the two layer enclosure. As will be described, in the preferred all layers fused together embodiments further additional adjacent layers are attached and melted to the two layer enclosure resulting in as many as six layers in the containment system.

In preferred embodiments the top lid is fabricated separately and is made up of two/three layers with matching compositions to the first, second and yet to be described third layer. In embodiments of this invention the prefabricated lid is of a precise mating shape to match the top surface edges of the two/three layer enclosure and is in-compression to the same level as the previously described two/three layer enclosure. In another embodiment of this invention the lid is fabricated in place and is made up of the same materials as the two/three layer enclosure. A Hot Glass Laser level measurement is preferably used to monitor the fabrication of the two/three layer lid to ensure that that the layer one, two and where desired, layer three materials do fuse together and make “wet” virgin contact of the surfaces. The hot glass laser level measurement is also used to measure the prefabricated lid as it rests down on the two/three layer enclosure so that data can be stored for future use. This data will map the bottom surface of the two/three layer lid as referenced to the two/three layer enclosure. The lids dimensions and thickness are such that it leaves a significant void in the two/three layer enclosure so that glass melting could occur in this void. Because the two/three layer vessel is made of high temperature glass materials (except for embodiments A10 and C3) the melting of vitrified nuclear radioactive waste material can take place in this void. The glassy nuclear radioactive waste material matrix has a lower melting temperature (≦1200 C.°) and higher expansion than the containment system glass layers (layer one, layer two or attached layer three glass materials). Table 2.5 shows from references highly tested (by references) and preferred nuclear waste glass materials for vitrification of nuclear radioactive waste. Preferably this radioactive waste melting mixture is aggressively agitated, bubbled or stirred to perform the preferred vitrification of the nuclear waste into the radioactive waste material layer four glass matrixes. This radioactive waste material fourth layer of vitrified nuclear waste glass is made and saturated with a high concentration of radioactive nuclear waste and can contain some unmelted batch material, defects, bubbles or heavy metal precipitants without substantially reducing the strength or integrity of the end resulting enclosed radioactive waste contained in the radioactive waste containment system. The hot glass laser level measurement is preferably used during the melting and fabrication of the radioactive waste material fourth layer (vitrified nuclear waste). In the preferred all layers fused together embodiments at a point before the maximum height of the radioactive waste material fourth layer height is reached the production and melting of radioactive nuclear waste glass would be stopped altogether and then a low defect rate glass with similar properties to the glass part of the radioactive waste material, such as soda lime glass would be used so that the level of this nonradioactive covering glass (layer five) is provided at a predetermined desired point where it will make contact with the underside of the top lid. Once the level is achieved the lid can be positioned and the interface of the lid and the hot glass is preferably monitored with the hot glass laser level measurement. This measurement also preferably insures that the wetting of the subsequent layer to the underside layer of the lid is successful. The top edges of the lid are preferably sealed to their respective glass interfaces with the vertical walls resulting in a uniform in-compressive ultra high strength enclosure. When all the containment layers are in melted together contact this is referred to as the preferred all layers fused together embodiments.

Table 1 shows preferred commercially available glass materials for the outermost exterior containment layer one enclosure of the containment system. The glass material's exterior containment layer properties λE CTE at room temperature (330° K) and at the possible in use temperature of 560° K are listed.

Table 2 shows the preferred glass materials for the adjacent interior containment layer two enclosures of the containment system. The glass material's adjacent interior containment layer property λ CTE at room temperature (330° K) and at the possible in use temperature of 560° K are listed.

Table 2.5 shows the preferred materials for the vitrified nuclear radioactive waste glass. The radioactive waste material's Young's Modulus and Modulus of Rupture at room temperature (300° K) are listed. The table also shows the approximate Melting and Softening Temperatures of the vitrified nuclear radioactive waste glass.

Table 3.1 shows the preferred next adjacent interior containment layer three glass materials that would be attached to the adjacent interior containment layer two materials for the preferred all layers fused together embodiments. The containment layer glass material's property CTE at the possible in use temperature of 560° K and the approximate melting temperature are listed.

Table 3.2 shows preferred materials for the next adjacent interior containment layer three materials for the preferred one layer not fused embodiments. The material's CTE, Young's Modulus and Modulus of Rupture at room temperature of 300° K along with the materials approximate melting temperature are listed.

Table 4 shows the glass material properties CTE matching of the preferred glass materials for the outermost exterior containment layer one and adjacent interior containment layer two enclosures for the preferred embodiments A1, A2, A3, A4, A5, A6, A7, A8, A9&A10 of the containment system. In addition it shows outermost exterior containment layer one and adjacent interior containment layer two glass materials approximate melting and softening temperatures along with the preferred difference in positive glass material property CTE for the two layer enclosure for the glass material combinations in preferred embodiments A1, A2, A3, A4, A5, A6, A7, A8, A9&A10.

Table 5 shows the material property CTE matching of the preferred materials for the outermost exterior containment layer one and adjacent interior containment layer two enclosures for the preferred embodiments B1 and B2. In addition it shows the outermost exterior containment layer one and adjacent interior containment layer two materials approximate melting and softening temperatures along with the preferred difference in positive glass material property CTE for the two layer enclosure for the material combinations in preferred embodiments B1 and B2.

Table 6 shows the glass material property CTE matching of the preferred materials for the outermost exterior containment layer one and the adjacent interior containment layer two enclosures for the preferred embodiments C1, C2 and C3. In addition it shows the outermost exterior containment layer one and adjacent interior containment layer two materials approximate melting and softening temperatures along with the difference in positive glass material property CTE for the two layer enclosure for the material combinations in preferred embodiments C1, C2 and C3.

Table 7 shows the calculated results of a stress model calculation for the preferred embodiments with the use of a three/four layer enclosure and the preferred all layers fused together embodiments with vitrified Iron phosphate (FeP) and Borosilicate (BS) Waste Glasses (WG) radioactive waste material.

Table 8 shows the calculated results of a stress model calculation for preferred embodiments with the use of a four/five layer enclosure and the preferred all layers fused together embodiments with vitrified Iron phosphate (FeP) and Borosilicate (BS) Waste Glasses (WG) radioactive waste material.

Table 9 shows the calculated results of a stress model calculation of four preferred embodiments with the use of a four layer enclosure and the preferred one layer not fused embodiments where the not fused material is Stainless Steel or Zirconium Metal.

Table 10 shows the calculated results of a stress model calculation of two preferred embodiments with the use of a four layer enclosure and the preferred one layer not fused embodiments where the not fused materials are Soda Lime Glass, Special Soda Lime Glass, Medium Expansion Glass Ceramic and Fused Silica Glass.

In preferred embodiments of the invention for making radioactive waste containment systems the method includes embodiments A1, A2, A3, A4, A5, A6, A7, A8, and A9. In preferred embodiments the invention includes encapsulating radioactive waste vitrified glass matrix material in the containment system. In embodiments the methods include fabricating and providing an outermost exterior containment layer from a high temperature preferred glass material with a containment layer property CTE such as shown in Table 1. In embodiments the methods include forming, fabricating and providing an adjacent interior containment layer two and fusing the adjoining molten glass material surface to the outermost exterior containment layer inner surface using the preferred glass materials such as shown in Table 2 and with the containment layer property CTE as shown in Table 2. Preferably the two layer enclosure of the outermost exterior containment layer and the adjacent interior containment layer two are used in subsequent process steps of making the containment system. In embodiments of the preferred all layers fused together embodiments, the methods include forming and fabricating a next adjacent interior containment layer three enclosure and fusing this layer's outside molten material surface to the adjacent interior containment layer two second layer surface using the preferred next adjacent interior containment layer three material shown in Table 3.1 with the containment layer property CTE as shown in Table 3.1. Preferably such containment system three layer enclosure is used in subsequent process steps. Preferably in one layer not fused embodiments the invention includes forming and fabricating a layer three material. Preferably in one layer not fused embodiments the invention includes using a glass material of the layer three glass materials shown in Table 3.1, preferably with a lower CTE than the vitrified nuclear radioactive waste that is to be contained inside the containment system. Preferably in one layer not fused embodiments with a metal based not fused material from Table 3.2 is used with a higher melting temperature than the vitrified radioactive nuclear waste that is to be contained in the containment system. Preferably a not fused material such as a packing fraction particulate material is disposed to isolates the layer three and layer four vitrified nuclear radioactive waste from adhering to the layer two material. Such is preferably disposed inside the outermost exterior containment layer containment system two layer outer enclosure. In embodiments the methods include fabricating a two or three layer lid and referencing the position of the lid's bottom surface to the two or three layer side walls of the containment system. Preferably radioactive waste glass matrix is melted and formed inside the two or three layer enclosure of the containment system to a predetermined level vertical height. In preferred embodiments of the invention with the all layers fused together, the methods include monitoring the melted glass level of radioactive waste to provide a predetermined level to provide a uniform melted and fused surface contacting the bottom surface of the two or three layer lid. Preferably the methods include placing the two or three layer lid on the containment system assembly while a covering top glass layer is in a hot glass molten state and then sealing the containment system side wall glass material layer edges and the layer edges of the lid together. Preferably the bottom layer of the lid does not contact the vitrified radioactive waste glass when using the preferred one layer not fused embodiments. Preferably the methods include sealing the outermost exterior containment layer one material indentation at the horizontal sealing plane of the lid by building up a compatible glass material that melts or wets and fuses to the outermost exterior containment layer one glass material. Preferably the methods include filling in the indentation void to at least the outer edges of the outermost exterior containment layer one material sealing the total enclosure in compression. Preferably the methods include slowly cooling and annealing the finally melted filled containment system to ambient atmospheric conditions and testing for the desired stress level and uniformity of the in-compression containment system. Preferably the methods include coating all outside virgin surfaces of the completed containment system three to five layer enclosures with a protective coating so that these outside surfaces have minimum handling or surface abrasion until the final radioactive waste containment storage is completed. If desired an additional outside metal enclosure for abrasion protection and to additionally minimize water penetration to the glass surfaces can be externally disposed.

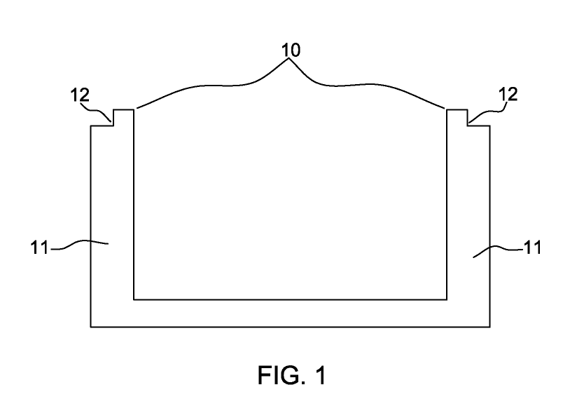

FIG. 1 shows an outermost exterior containment layer one rectangular enclosure (11) without the lid where edges (10) have been fabricated to a smooth predetermined height. Outermost exterior containment layer 11 is comprised of an outermost exterior containment layer glass material having an exterior containment layer property a. The outside lip (12) will be sealed as one of the final steps after the containment system is filled with radioactive waste.

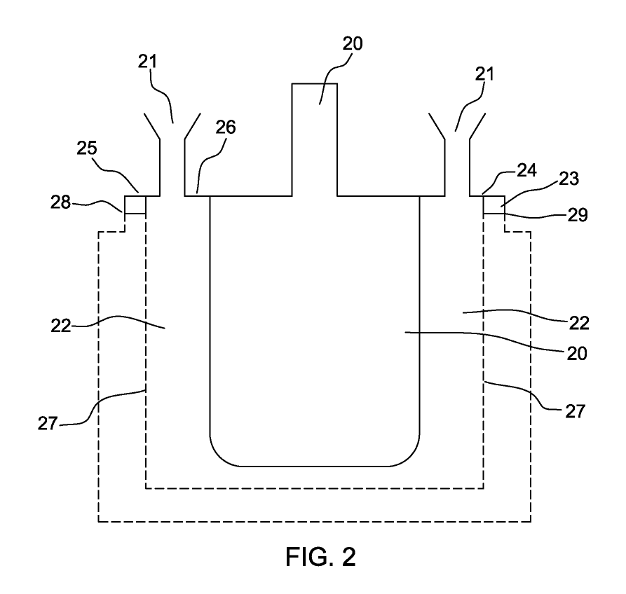

FIG. 2 shows a mold (20) used to fabricate an adjacent interior containment layer two inside an outermost exterior containment layer one enclosure (27). The mold (20) preferably has raised edges (24) and (26) that are defined by edges (23) and (25) of the mold. Inlets (21) of the mold (20) are used to fill the void with an adjacent interior containment layer two glass material having an adjacent interior containment layer glass material property λ2, with the glass material filled up to edge (24) and (26) of the mold. Preferably the adjacent interior containment layer two glass materials in Table 2, with the possible exception of fused silica, can be fabricated from a melted glass material molten stream state. In a preferred embodiment of this invention the top edges of layer two (24) and (26) are shaped or made flush with the top edges of outermost exterior containment layer one edges (28) and (29) before the full in-compression stress level is set by the difference in glass material properties CTE of the two glass materials. The spacing (22) between the mold (20) and the inside edge of outermost exterior containment layer one (27) is filled with molten glass material that is fused and wetted to the inside edge of outermost exterior containment layer one (27). In an embodiment of this invention the adjacent interior containment layer two enclosure is made of a Borosilicate Glass. In other embodiments of this invention the adjacent interior containment layer two is made of a Low Expansion Glass Ceramic, a Medium Expansion Glass Ceramic, a Magnesium Aluminosilicate Glass, a Germanium Oxide Silicate Glass, a Fused Silica Glass, a Soda Lime Glass, or a Special Soda Lime Glass. In an alternate embodiment of this invention the adjacent interior containment layer two is prefabricated. In a similar manner as taught here this prefabricated shape of the adjacent interior containment layer two enclosure is then place inside the outermost exterior containment layer one enclosure. The interface between this prefabricate adjacent interior containment layer two enclosure and the inside surface of the outermost exterior containment layer one enclosure is then filled and fused with the same defect free molten layer adjacent interior containment two glass material to the inside surfaces of the outermost exterior containment layer one enclosure. This is a preferred method to attach adjacent interior containment layer two soda lime glass material to outermost exterior containment layer one of preferred embodiment A10 since the melting temperature of adjacent interior containment layer two glass material is lower than the melting temperature of the outermost exterior containment layer one borosilicate glass material.

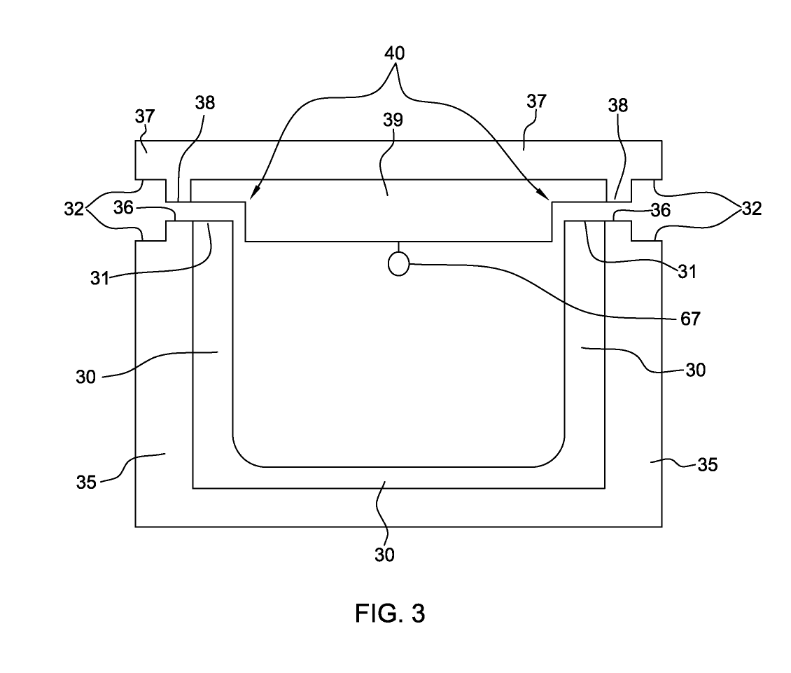

FIG. 3 shows a two layer rectangular enclosure containment system with adjacent interior containment layer (30) and outermost exterior containment layer (35) with the two layer lid with glass material layers (37) and (39) nearly resting on the two layer enclosure top surfaces (36) and (31) of adjacent interior containment layer (30) and outermost exterior containment layer (35) after the top surfaces (31) of adjacent interior containment layer (30) has been shaped flat. The two layer lid has layer one (37) and layer two (39) shaped as shown for a near perfect fit to the vertical side walls of adjacent interior containment layer (30) and outermost exterior containment layer (35). The two layer lid (37) and (39) are made so that edge (38) and (40) match to the layer one (36) and layer two (31) edge interfaces. Layer (39) of the lid, had in its previous molten state, its top surfaces in melted material contact (“wet glass contact”) with glass material layer (37) to achieve the same in-compression level as the two layer enclosure adjacent interior containment layer (30) and outermost exterior containment layer (35) without the lid. A predetermined calculated volume of layer two material in the form of an extension (67) to the lid is disposed as part of the lid's second layer (39) and is used in preferred all layers fused together embodiments as one of the final process steps in filling the containment system with waste to insure that the excepted minimal atmospheric gaseous void at the bottom surface of the lid is moved away from that surface to a different distal layer four or five during the final attachment of the lid to the outer enclosure outermost exterior containment layer and adjacent interior containment layer vertical side walls. The calculated predetermined volume of the lid extension (67) is based on the variation in the vertical glass level, the thickness variation of the lid and any dimensional variation in the side walls above the final predetermined Glass level. Indentations (32) in the outermost exterior containment layer one enclosure are preferably wet glass material contact sealed with outermost exterior containment layer one glass material in a later process step.

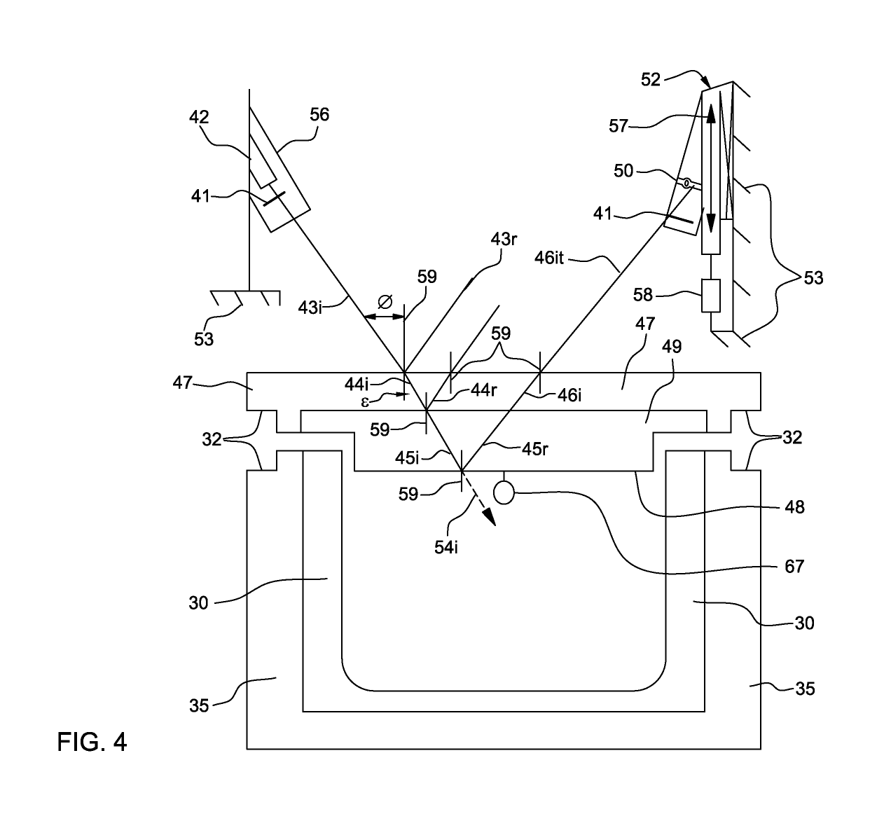

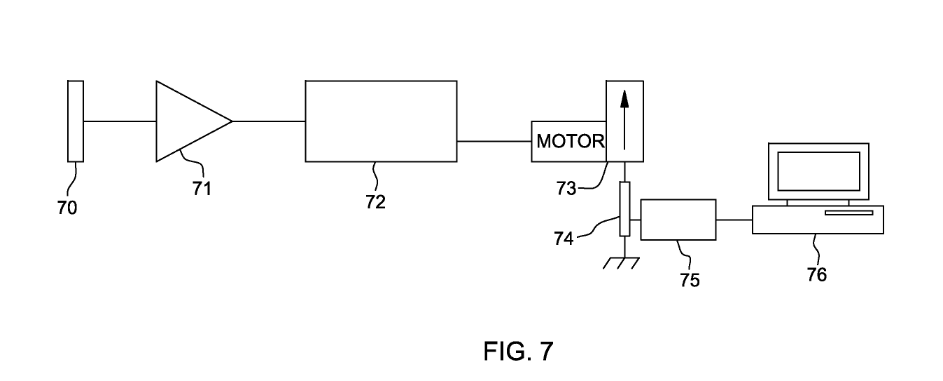

FIG. 4 shows a, lid with glass material layers (47) and (49) nearly resting on top of a containment layer outermost exterior containment layer (35) and adjacent interior containment layer (30). It also shows a laser level measurement system used in the hot melting of glass material to measure the melted glass. A visible light laser (40) is in a water cooled housing (56) with a narrow band interference filter (41) producing the beam of incident laser light 43i. Incident laser beam 43i reflects off of the top glass surface of the glass material layer (47) of the lid and is reflected into the atmosphere as a stray reflected beam 43r. The incident beam 43i is refracted in glass material layer (47) of the lid by the normal Snell's law of geometric optics. This law then governs that resulting beam ray 44i is refracted into glass material layer (47) lid layer one at a specific angle (ε) to the normal (59) and proceeds onto the interface of glass material layer (47) and glass material layer two (49) of the lid. If the interface of glass material layer (47) and glass material layer two (49) makes the wet glass contact no reflection beam or a very weak reflection beam will occur at that interface as reflected beam 44r. Incident beam 44i then proceeds into the glass material layer two (49) of the lid as beam 45i and is then reflected off of the glass to air interface at the bottom edge surface (48) of the glass material layer two (49) of the lid as beam 45r. Beam 45r then becomes beam 46i as it refracts back into glass material layer one (47) of the lid and emerges from the two layer lid as beam 46it. As will be described the vertical position of this laser beam 46it will correspond and measure the bottom surface (48) of the two layer lid made up of glass layers (47) and (49). The laser beam 46it is then incident onto a narrow band interference filter (41) and position sensitive Quadrant detector (50). Detector (50) senses the centroid position of the beam 46it in the x y plane of the detector. Detector (50) is interfaced with an amplifier that produces a voltage proportional to the position of light beam 46it in the x y plane of housing (57). When the position of light beam 46it is in the center of detector (50) the voltage output of the amplifier would be zero. FIGS. 4 &7 shows the components and FIG. 7 shows the electronic processing of this hot glass laser level measurement. In FIG. 4 and FIG. 7 this position sensitive quadrant detector (50), (70) is interfaced to its amplifier (71). The amplifier is connected to a three mode motor controller (72) which drives a single axis vertical slide (52), (73) in the vertical (Z) direction only until the output of detector (50), (70) with its amplifier is zero. This vertical position of the slide is measured by a linear displacement transducer (58), (74). The voltage output of the linear position transducer then exactly tracks or measures the bottom surface (48) of the lid. The Voltage output of the linear position transducer (58), (74) is conditioned by its amplifier (75) and the output data is stored in the computer (76). In this embodiment of this invention as shown in FIG. 4 the angle of incidence (Ø) of laser beam (43i) is kept constant.

When the reference surfaces (53) in FIG. 4 are moved together horizontally the measurement will accurately map the complete bottom surface (48) of the lid. This measurement data is taken as a reference so that a molten glass layer can be filled exactly to this reference level. In FIG. 4, when molten glass radioactive waste is disposed inside the outermost exterior containment layer (35) and its adjacent interior containment layer (30) and does fill the void of the containment system the incident beam 54i would reflect off of that surface. This reflection would then proceed toward the detector housing (57) of the hot glass laser level measurement system and replace beam 46it as previously described in the measurement of the bottom surface of the two layer lid. The position of the lid extension controlled volume (67) is also measured and the data can be removed from the bottom surface (48) data of the two layer lid. In like manner the laser level measurement can also be used to measure and test the transparent glass material surfaces of a containment system enclosure's wet glass contact fused interfaces. Such testing is preferably used to verify that the fused, wet glass interfaces did in fact occur.

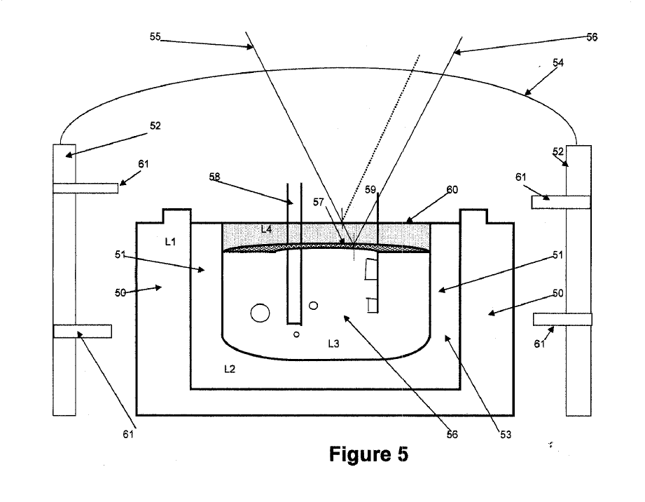

FIG. 5 shows a sectional view of a containment system with outermost exterior containment layer (50) (glass material layer L1) and adjacent interior containment layer (51) (glass material layer L2) inside a furnace (52) for melting the vitrified glass matrix radioactive nuclear waste (56) into its glassy state. The furnace (52) is heated by an energy source preferably by gas oxygen burners (61) to a high enough temperature that the furnace melts the higher expansion, lower melting temperature (≦1200° C.) radioactive waste and glass materials into a vitrified glass matrix nuclear waste (56). Alternate Energy sources such as electric heating of the glass matrix are possible. The Softening temperature of outermost exterior containment layer (50) (glass material layer L1) and adjacent interior containment layer (51) (glass material layer L2) are higher than the melting temperature of the nuclear waste glass matrix (56) (radioactive waste glass material L3) so that the containment system containment layers (50), (51) do not significantly change in shape or integrity. Preferably Bubbler (58) and mechanical stirrer (59) are used to help melt and increase the concentration of the nuclear radioactive waste incorporated into the glass matrix (L3). The incoming laser beam (55), which is the same schematically, as beam 43i in FIG. 4 is used to monitor the melted nuclear radioactive waste glass (L3) level to a predefined point (57) in order to leave space for a layer four (L4) material. The bubblers and stirrers are removed and the layer four glass material (L4), which in a preferred embodiment of this invention is a glass with similar glass material properties to soda lime glass, is added and melted to a predetermined uniform glass level. This is done so that the low defect free glass of this top layer (L4) can contact the bottom surface of a lid disposed above it, resulting in a uniform in-compression interface and enclosure. This predetermined level seals the top surface (60) of the top layer glass material (L4) with the underside surface of the lid. This void less (and near void less) sealing significantly increase the strength of the total enclosure after the containment system is filled with radioactive waste glass (L3) and sealed and retards any penetration of water or other minerals and is a benefit of the preferred all layers fused together embodiments.

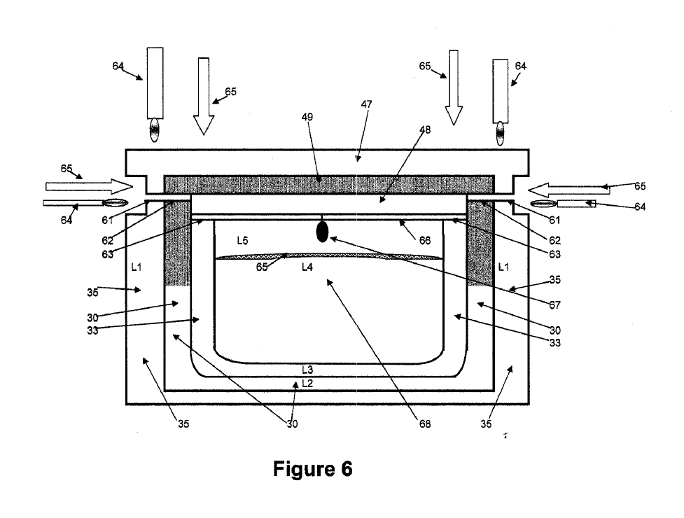

FIG. 6 shows a preferred embodiment of the invention using the preferred all layers fused together embodiments where a three layer lid (glass material layer 47), (glass material layer 49) and (glass material layer 48) is placed on top of the three layer enclosure containment system (outermost exterior containment layer (35) comprised of glass material L1) (adjacent interior containment layer (30) comprised of glass material L2) (next adjacent interior containment layer (33) comprised of glass material L3). As shown in FIG. 6, the next adjacent interior containment layer (33) comprised of glass material L3 is the innermost waste adjacent interior containment layer in that it is directly adjacent to the radioactive waste glass material L4. Preferably the three layer lid is disposed while the layer five glass material (L5) is molten hot and at an exact predetermined level (66). Also while the containment system assembly is at an elevated temperature the layer one outermost exterior containment layer 35 (glass material L1), the layer two adjacent interior containment layer 30 (glass material L2), and the layer three next adjacent interior containment layer 33 (glass material L3) are all sealed at their respective edge (61), (62) and (63) with liquid glass/glass frit that is melted in place with additional high temperature focus burners (64) and/or carbon dioxide laser beams (65). The glass frit is preferably a fine ground glass/glass ceramic of preferably the same composition as the respective glass materials (L1, L2, L3). Also in a preferred embodiment the three layer lid (glass material layers 47,49 and 48) are sealed at the interface with the layer five glass surface (66) of the glass material (L5), where the layer five glass surface (66) has a complete molten glass contact with the underside of the lid glass layer (48). In a preferred embodiment the layer five glass material (L5) would be soda lime glass/special soda lime glass. In addition, in FIG. 6 the nuclear waste (68) and the radioactive waste glass (L4) has its top surface (65) in contact with the layer five glass material (L5). In another embodiment of the invention glass soot could be used that could also seal edges (61), (62) and (63). The fabrication of the soot is explained later. It is preferred that the frit/soot match the same glass composition of the respective layers of the containment system so that minimal stress occurs at the joints (61), (62) and (63). During this attachment of the three layer lid the predetermined calculated lid extension (67) will insure that atmospheric gasses will be moved upward as a void to layer five glass material (L5) in FIG. 6.

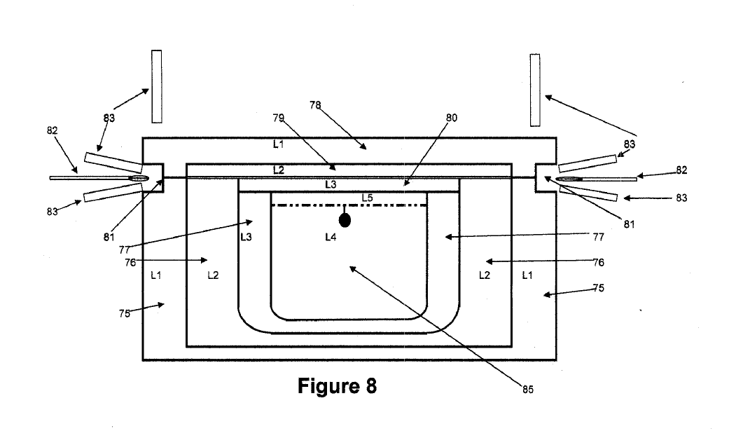

FIG. 8 shows a radioactive waste containment system where the indentation (81) in the outermost exterior containment layer (75) and outermost exterior containment lid layer (78) comprised of outermost exterior containment layer glass material (L1) having exterior containment layer property λE with the sealing of the indentation (81) after the containment system had been filled with radioactive waste. In a preferred embodiment of this invention the indentation (81) is filled with hot glass using a flame hydrolysis method of making soot with a similar composition and manner as the layer one material was preferably formed. In FIG. 8 focused burners (82) are used to consolidate the soot particles as they are formed. It is preferred to match the composition of layer one outermost exterior containment layer glass material (L1) (outermost exterior containment layer 75 and outermost exterior containment lid layer 78) or use a composition that is slightly lower in CTE so that the total outside of the layer one enclosure outermost exterior containment layer glass material (L1), the outermost exterior containment layer 75 and the outermost exterior containment lid layer 78 are in-compression. This will completely seal the outside of the radioactive waste enclosing containment system so that any possible penetration of water is delayed. Using Corning Published data on the chemical durability of Fused Silica in deionized water at 330° K temperature, with the outermost exterior containment layer glass material (L1), the outermost exterior containment layer 75 and the outermost exterior containment lid layer 78 provided with a 6 inch (15.2 cm) thickness it would take water much greater than 1000 years to completely degrade the Fused Silica in such outermost exterior containment layer. Even if such happened, the layer four radioactive waste glass material (L4) with the radioactive waste (85) is still protected by the layer two adjacent interior containment layer (76) formed from adjacent interior containment layer glass material (L2) and also by the layer three next adjacent interior containment layer (77) formed from next adjacent interior containment layer glass material (L3) and layer five glass material (L5). As shown in FIG. 8, next adjacent interior containment layer (77) formed from next adjacent interior containment layer glass material (L3) is the innermost waste adjacent interior containment layer (77) formed from the innermost waste adjacent interior containment layer glass material (L3) in that it is adjacent to and containing the radioactive waste glass material (L4). In FIG. 8, the five layer enclosure containment system, using the preferred all layers fused together embodiments, is then very slowly cooled or annealed to atmospheric ambient conditions. In the optical glass manufacturing field, this is often done to control or minimize stress in optical glasses. Such cooling/annealing of the containment system is preferred to ensure that the tension stress between each of the fused melted joints and glass material layers is minimal. Preferably the five layer enclosure when it is at atmospheric conditions is coated on all outside surfaces of the outermost exterior containment layer glass material (L1) to minimize abrasion during subsequent handling and storage. Many commercially available coating could be used to achieve this protection while the containment system is stored and transported to its final storage location assumed to be somewhere deep in the earth's surface. Three commercially available protective coating are listed below:

| Manufacture | Name | Description | Current Use |
|---|---|---|---|
| Corning Inc | CPC ® | A stiff high modules | Secondary |
| | Coating | coating | coating on |
| | | | optical fiber |
| General | Disccoat 4210 | A high modules | Used on |
| Chemical | | temporary, protective, | glass, wafers, |
| Corp. | | peel able coating | photo masks, |
| | | | optical media |
| | | | and optical |
| | | | disks |
| PCT Global | EnduroShield | A permanent | Commercial |
| PTY Ltd | | hydrophobic and | Glass |
| | | oleophobic coating | products |
| | | for glass | |

In other embodiments of the invention the layer five glass material (L5) shown in FIG. 8 is not used and the layer four vitrified radioactive glass material (L4) is filled to the point where it makes contact with the bottom surface of the layer three material of the three layer lid glass material (L3) shown in FIG. 8. Also, in other embodiments of this invention the shape of the enclosure of the containment system could be of a different cross section shape, such as a cylindrical or spherical cross section.

After the fabricated three or five layer enclosure containment system is made and brought to ambient atmospheric conditions it can be tested. The laser level measurement system can be used to scan the glass material surfaces and insure that the glass material layers and their joining interfaces have no voids and that the glass materials of the layers are in molten material fused glass contact. An optical birefringence measurement can be used to measure the level and uniformity of stress in optical components made from glass materials. These same optical birefringence measurement techniques and procedures can be applied and used on the containment system and its glass layers. Such measurements would confirm the uniformity and in-compression stress levels of the containment system. The made three or five layer glass material enclosure containment system could then be encased in metal to further prevent water migration and add additional abrasion protection to the outside of the three to five layer enclosure

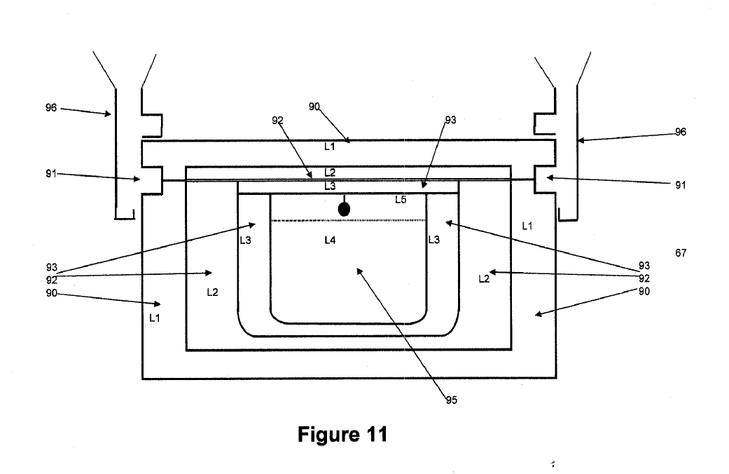

The making of a multilayer enclosure glass material containment system for the preferred embodiments B1 and B2 is disclosed. Table 5 shows the match up of the outermost exterior containment layer glass material (L1) layer one and adjacent interior containment layer glass material (L2) layer two materials for the preferred in-compression levels of these two preferred embodiments. Preferred methods of making embodiments B1 and B2 are similar to the process step in the disclosed preferred embodiments A1, A2, A3, A4, A5, A6, A7, A8 and A9. The first notable exception is that the outermost exterior containment layer glass material (L1) layer one and adjacent interior containment layer glass material (L2) layer two enclosure containment layers are formed in the reverse order. In preferred embodiment B2 the adjacent interior containment layer glass material (L2) layer two which is formed first is a fused silica glass such as shown in Table 1. In preferred embodiment B2 the outermost exterior containment layer glass material (L1) layer one material is a low expansion glass ceramic, preferably such as either Corning's Pyroceram® 9963 or Schott's 200Zerodur®. In the preferred embodiment B2 both adjacent interior containment layer glass material (L2) layer two and the outermost exterior containment layer glass material (L1) layer one are formed by conventional glass material manufacturing methods. The remaining process steps for preferred embodiment B2 are the same as preferred embodiments A1, A2, A3, A4, A5, A6, A7, A8 and A9 except for the sealing of the layer one indentation (91) as show in FIG. 11. FIG. 11 shows a containment system where the indentation (91) in the outermost exterior containment layer glass material (L1) layer one is sealed. In a preferred embodiment of this invention the indentation (91) is filled with the hot glass of the glass material composition glass material (L1) that forms the outermost exterior containment layer (90). In FIG. 11 mold (96) is attached to the filled containment system enclosure and this mold is filled with the melted hot outermost exterior containment layer glass material (L1). As needed Focused burners or a furnace are used to complete the wet glass sealing attachment and any ceraming when needed with glass ceramic glass materials. It is preferred to match the composition of the layer one glass material composition glass material (L1) that forms the outermost exterior containment layer (90) or use a glass material composition that is slightly lower in CTE so that the total outside of the layer one outermost exterior containment layer (90) is in-compression. This slightly lower CTE adjustment can be accomplished with a modification of the composition of the outermost exterior containment layer glass material (L1). If desired the outside edge of the indentation (91) from mold (96) could be shaped or made flat to the outside surface of outermost exterior containment layer (90). This will completely seal the outside of the enclosure so that any possible penetration of water is delayed. Corning's low expansion glass ceramic Pyroceram® 9963 and Schott's 200Zerodur® have excellent chemical durability in water.

In preferred embodiments such as B1 the adjacent interior containment layer glass material (L2) which is formed first is a fused silica glass such as shown in Table 1. In this preferred embodiment B1, the enclosure would have a cylindrical cross section. In preferred embodiment B1 the cylindrical cross section is preferred for its practicality and economic cost effectiveness. In this preferred embodiment B1 the fused silica adjacent interior containment layer glass material (L2) is formed first and in this preferred embodiment is preferably fused silica tubing. Fused silica tubing is available from a number of suppliers, such as suppliers to the optical fiber manufacturing industry, or it could be fused silica fabricated in place using flame hydrolysis. In using commercially available fused silica tubes such as Suprasil® fused silica tubes from Heraeus Amersil as shown in Table 1 it is preferred that the outside surface of these tubes do not contain any defect or abrasions so a process step is added. The outside of such tubes are preferably over clad using flame hydrolysis to deposit fused silica. This could seal some defects but more importantly it moves any such defects away from this area of the tubing. This area is in tension once the outermost exterior containment layer of exterior containment layer glass material (L1) is fused to such fused silica glass material (L2) of the fused silica tube adjacent interior containment layer. This area of tension occurs as a natural reaction in all preferred embodiments due to the desired in-compression level of the outside surfaces of the two glass materials selected glass material properties CTE mismatch.

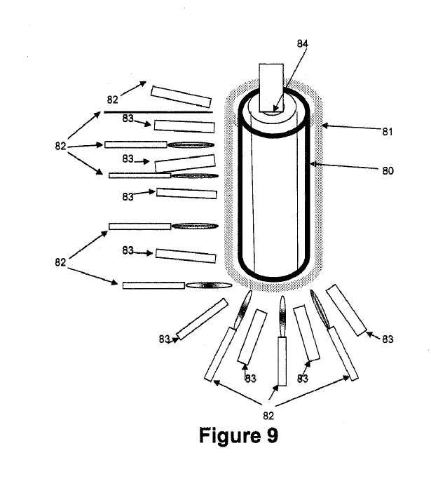

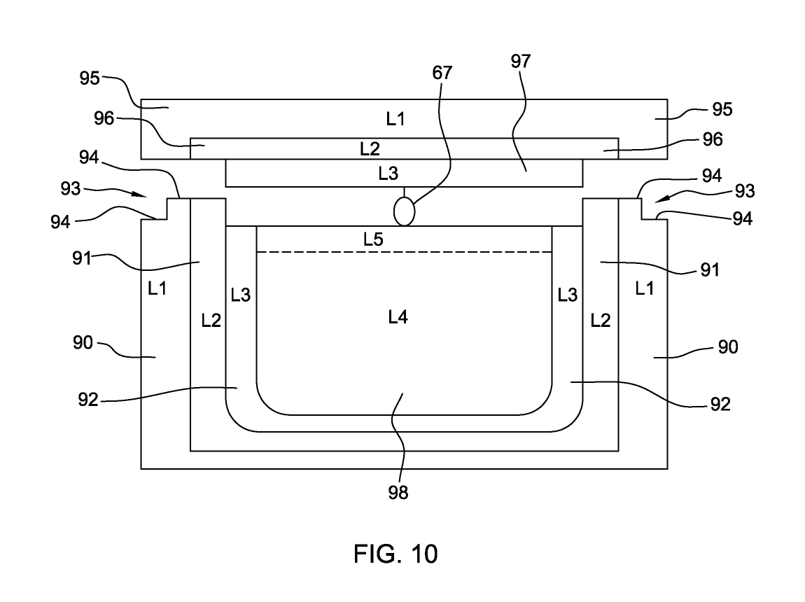

FIG. 9 shows fused silica tubing (80) attached to a mandrel (84) which can be rotated and moved vertically. FIG. 9 shows for preferred embodiment B1 the outermost exterior containment layer one glass material having a composition similar to Corning's ULE® glass to provide an outermost exterior containment layer having an exterior containment layer property λE such as the thermal expansion property of Corning's ULE® glass. It is preferably fabricated by flame hydrolysis preferably with high purity feedstocks such as silicone tetrachloride and titanium chloride. Such feedstock components are fed into gas oxygen burners (83) to produce soot that is then consolidated by focused burners (82). The layers of soot are built up, formed and consolidated to the final desired dimension on the outside of the fused silica tubing (80) as outermost exterior containment layer (81). If the titanium chloride feedstock is turned off the described process with only silicone terrachloride will make high purity fused silica glass. This two layer tube enclosure is then preferably formed into a three layer enclosure by using one of the glasses in Table 3.1. This layer three glass from Table 3.1 is preferably conventionally melted as a batch melted glass that is then provided as a flowing stream of melted glass with the inside third layer next adjacent interior containment layer formed inside the two layer tube enclosure by a conventional method of stream feeding the melted glass flowing stream to the inside walls and then plungering the applied melted glass to create the interior void for reception of further materials. Since the glass materials in Table 3.1 have a melting temperature a few hundreds of degree ° C. lower than the softening temperature of the outermost exterior containment layer and the adjacent interior containment layer fused silica tube, conventional stream feeding and forming is preferably used. The next adjacent interior containment layer three material is again hot glass melted and fused to the layer two inside surface of the fused silica tube. FIG. 10 shows the outermost exterior containment layer (90) comprised of exterior containment layer glass material (L1), the adjacent interior containment layer (91) comprised of adjacent interior containment layer glass material (L2), and the innermost waste adjacent interior containment layer (92) comprised of innermost waste adjacent interior containment layer glass material (L3). The outside top edges (94) of the outermost exterior containment layer (90) are shaped with indentation (93). FIG. 10 also shows a cylindrically shaped three layer lid with top exterior layer (95) comprised of exterior containment layer glass material (L1), middle adjacent interior layer (96) comprised of adjacent interior containment layer glass material (L2) and next adjacent interior layer (97) comprised of innermost waste adjacent interior containment layer glass material (L3). In preferred embodiment B1 the other process steps and aspects of preferred embodiments A1, A2, A3, A4, A5, A6, A7, A8 and A9 are used to make, fill, and seal containment system. The filled containment system with five layers of glass material is then slowly cooled and annealed to ambient atmospheric conditions. As already described the containment system can be tested for the hot glass fused contact of the glass material interface surfaces and for its uniform in-compression stress level. It would then preferably be coated with a protective coating to minimize abrasion as already described.

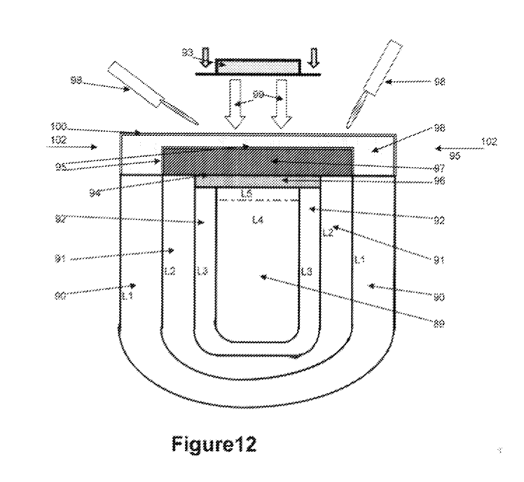

Additionally in FIG. 10 the three layer lid with glass material layers (95, 96 & 97) could be replaced with a lid that is fabricated in place after the layer four radioactive glass material (L4) is melted and the layer five glass material (L5) has been melted and set up to the desired height. An example of a lid formed in place is shown in FIG. 12. In FIG. 12 glass frit (96) of the composition of the glass material innermost waste adjacent interior containment layer glass material (L3) is disposed on top of the layer five glass material (L5). This frit (96) can be compacted by mechanically compression with press (93) and then made into a molten glass surface by focus burners (98) or Carbon Dioxide Lasers (99). Layers of frit (96) are added, melted and built up until the glass material innermost waste adjacent interior containment layer glass material (L3) of the lid is at the correct height (94) to match the layer three edge (94) of the three glass material layers (L1, L2 &L3). Subsequently frit (97) of the composition of the adjacent interior containment layer glass material (L2) is added, melted into a molten material and built up until it reaches the desired dimension (95). Subsequently frit (98) of the composition of exterior containment layer glass material (L1) is added, melted into a molten glass material and built up until it reaches the desired dimension (100) of the exterior containment layer glass (L1). An advantage of this in place fabrication of the lid is that the layer one exterior containment layer glass material (L1) of the lid can be used to overfill or over build the lid at the joint (102) to the outer edge of outermost exterior layer one of the three layer enclosure containment system. This would help to ensure that water penetration can be delayed from eroding thru the three layer lid to the nuclear radioactive waste glass material (L4) and its radioactive waste (89). In FIG. 12 an alternative to using frit and heating to form the lid would be to stream feed already melted molten layer three glass material (L3) to the desired height (94) using the previously disclosed hot glass laser level measurement. This is a preferred method because most of the layer three glass material (L3) in Table 3.1 can be conventionally melted, stream fed and formed with conventional glass furnace melting and stream feeding.

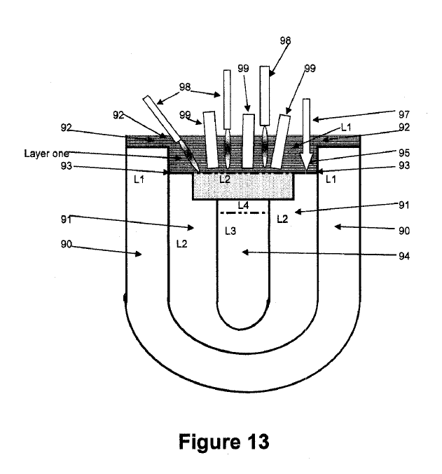

In similar manners the two layer or three layer lid could be fabricated in place using soot deposition and high temperature glass melting as a fabrication process. An example of this for a two layer lid is shown in FIG. 13. In FIG. 13, glass soot is formed by flame hydrolysis feedstock fed burners (99) and deposited on top of the glass material (L4) that is directly covering the radioactive waste glass material (L3). This soot is consolidated and made into a molten glass material (L2) by focus burners (98) or carbon dioxide lasers (97). Layers of soot are deposited, melted and built up until the layer two glass material (L2) of the lid is at the correct height (93) to match the layer two edge of the adjacent interior containment layer (91). Subsequently soot of the composition of the layer one exterior containment layer glass (L1) is added, melted into a molten material (95) and built up until it reaches the desired height (92) of the layer one outermost exterior containment layer (90). An advantage of this in place fabrication of the lid is that the layer one exterior containment layer glass (L1) of the lid can be used to overfill or over build the lid at the joint (92) to the outer edge of layer one of the two layer enclosure, which helps to ensure that water penetration can be delayed from reaching the radioactive waste glass material (L3).

The fabrication of a multilayer enclosure for preferred embodiments C1 and C2 is disclosed. Table 6 shows the match up of the layer one outermost exterior containment layer glass material (L1) and adjacent interior containment layer glass material (L2) for the preferred in-compression levels of these two preferred embodiments. Preferred embodiments C1 and C2 are similar to the process step in the disclosed preferred embodiments A1, A2, A3, A4, A5, A6, A7, A8 and A9. The first exception is that the layer one and layer two enclosures are formed in the reverse order. In preferred embodiments C1 and C2 the layer two material adjacent interior containment layer glass material (L2) which is formed first is Corning's medium expansion glass ceramic Pyroceram® 9606. In this preferred embodiment such containment layer is formed in the conventional method of melting the glass and molding with a thermally cooled plunger. Subsequently the layer two glass material can be ceramed to nucleated ceramic crystals. In preferred embodiment C1 the exterior layer one material is a borosilicate glass as shown in Table 2. In preferred embodiment C2 the exterior layer one material is Corning's low expansion glass ceramic Pyroceram® 9963. The second difference between preferred embodiments A1, A2, A3, A4, A5, A6, A7, A8, and A9 and preferred embodiment C2 is that in preferred embodiment C2 the Softening temperature of the layer two materials is similar to the exterior layer one material's melting temperature. Since the layer two material has excellent thermal shock resistance this adjacent interior containment layer two can be thermal cooling while the exterior layer one enclosure is formed. This cooling of this adjacent interior containment layer two enclosure can be accomplished with a thermal cooled plunger with a preferred matched mating shape to make good thermal contact to the inside surface of this adjacent interior containment layer two enclosure. Preferably the other process steps covered previously in the disclosed preferred embodiments A1, A2, A3, A4, A5, A6, A7, A8 and A9 are used and apply to embodiments C1 and C2 except for the final sealing of the layer one indentation which is shown in FIG. 11.

FIG. 11 shows a five layer enclosure where the indentation (91) in the outermost exterior containment layer one that is comprised of exterior containment layer glass material (L1) having exterior containment layer property λE can be sealed with a glass material disposed in indentation (91). In a preferred embodiment of this invention the indentation (91) is filled with a hot glass material having the composition and property of the exterior containment layer glass material (L1) that comprises the outermost exterior containment layer one (90), including the vertical side walls, the containment layer bottom, and the lid exterior containment layer. In FIG. 11 mold (96) is attached to the five layer enclosure containment system outermost exterior containment layer (90) and this mold is filled with the melted hot exterior containment layer glass material (L1). As needed focused burners or a furnace are used to complete the wet glass sealing attachment and ceraming. It is preferred to match the composition of the exterior containment layer glass material (L1) that comprises the outermost exterior containment layer one (90) or use a similar glass composition that has a glass property λEL slightly lower in CTE so that the total outside of the outermost exterior containment layer one enclosure (90) is in-compression. This slightly lower CTE adjustment glass property λEL can be accomplished with a modification of the composition of the exterior containment layer glass material (L1). The outside edge (91) from mold (96) can be shaped or made flat to the outside surface of outermost exterior containment layer one (90). This preferably seals the outside of the containment system enclosure so that any possible penetration of water is delayed. Corning's low expansion glass ceramic Pyroceram® 9963 and borosilicate glass have good chemical durability in water. After sealing closed the filled containment system five layer enclosure is then slowly cooled and annealed to ambient atmospheric conditions. The closed filled containment system is preferably tested for void free fused contact of the layers wet glass interfaces and measured for uniform stress. The closed filled containment system is preferably coated for abrasion protection during handling.

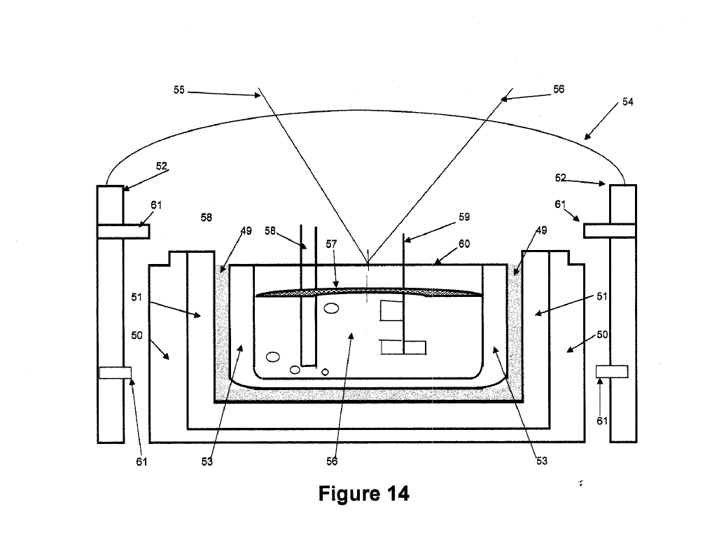

The fabrication of multilayer enclosing containment systems for preferred embodiments with the preferred one layer not fused are disclosed. In the preferred one layer not fused embodiments, the containment system is different from the preferred all layers fused together embodiments in a number of ways. In the preferred one layer not fused embodiments the innermost waste adjacent interior containment layer is comprised of a innermost waste adjacent interior containment layer glass material (L3) or the innermost waste adjacent interior containment layer may be comprised of a metal. This innermost waste adjacent interior containment layer three (not fused layer) is not attached to the adjacent interior containment layer two comprised of adjacent interior containment layer glass material (L2) because it is desired to not have the innermost waste adjacent interior containment layer three or the radioactive waste glass material layer four radioactive waste materials (L4) induce stress to the adjacent interior containment layer and its outermost exterior containment layer. Table 3.2 shows a preferred list of preferred materials for layer three using the preferred one layer not fused embodiments including glass materials and nonglass metal materials. As disclosed using a stress model the first five glass materials in Table 3.2 are preferred. The first three disclosed materials in Table 3.2 have a glass material property CTE from 0.05 to 0.38 ppm/° Kat 560° K and a very high melting temperature greater than 1400° C. These first three disclosed materials in Table 3.2 also have a high tolerance to thermal shock and have a material softening temperature that is at least 200° C. higher than the estimated melting temperature of the nuclear radioactive waste glass (1050 to 1160° C.). These three glasses materials permit the melting of the vitrified nuclear radioactive waste without significantly changing the containment systems enclosure's shape or strength. The remaining two glasses in Table 3.2, the Soda Lime Glass and the Special Soda Lime Glass require different forming processes. The first three high temperature glass materials in Table 3.2 are made, formed and inserted into the containment system outer two layer enclosure comprised of the adjacent interior containment layer and its outermost exterior containment layer. The innermost waste adjacent interior containment layer three may be formed, fabricated and melted as a uniform contiguous glass material body or it could be made from separate interlocking glass material pieces. To insure that the innermost waste adjacent interior containment layer three materials does not adhere to the adjacent interior containment layer and its outermost exterior containment layer two, not fused together particulate packing material, such as glass frit/silica sand particles are preferably disposed between the adjacent interior containment layer two and the innermost waste adjacent interior containment layer three materials. FIG. 14 is similar to FIG. 5 and illustrates the use of high melting temperature (≧1300° C.) glass materials in the preferred one layer not fused embodiments. FIG. 14 shows a sectional view of an exterior two layer enclosure comprised of the adjacent interior containment layer (51) and its outermost exterior containment layer (50) in a furnace (52) melting the radioactive nuclear waste (56) into a vitrified glass matrix glass material (L4). In FIG. 14 the innermost waste adjacent interior containment layer (53) are set inside the two layer enclosure adjacent interior containment layer (51) and its outermost exterior containment layer (50) with glass frit packing fraction particles (or fine round silica sand packing fraction particles) (49) supporting the innermost waste adjacent interior containment layer (53). The furnace (52) is heated by an energy source preferable by Gas Oxygen burners (61) to a high enough temperature that it can melt the higher expansion, lower melting temperature (≦1200° C.) nuclear radioactive waste glass (L4) into a vitrified glass matrix material containing radioactive waste (56). Alternate Energy sources such as electric heating of the radioactive glass matrix are possible. The Softening temperature of layer one outermost exterior containment layer (50), its layer two adjacent interior containment layer (51) and layer three innermost waste adjacent interior containment layer (53) are much higher than the melting temperature of the vitrified nuclear glass matrix of radioactive waste (56) so that these containment system layers do not significantly change shape or integrity during the heating. Preferably bubbler (58) and mechanical stirrer (59) are used to help melt and increase the concentration of the nuclear radioactive waste (56) into the glass matrix glass material (L4). The incoming laser beam (55) similar to beam 43i in FIG. 4 is used to monitor the melted glass level (57) to a predefined point in order to leave space so that the radioactive waste glass material and the innermost waste adjacent interior containment layer (53) do not contact a two layer lid top that may be disposed on top of and seal with layer one outermost exterior containment layer (50) and its layer two adjacent interior containment layer (51). In FIG. 14 the bubblers and stirrers are then removed.

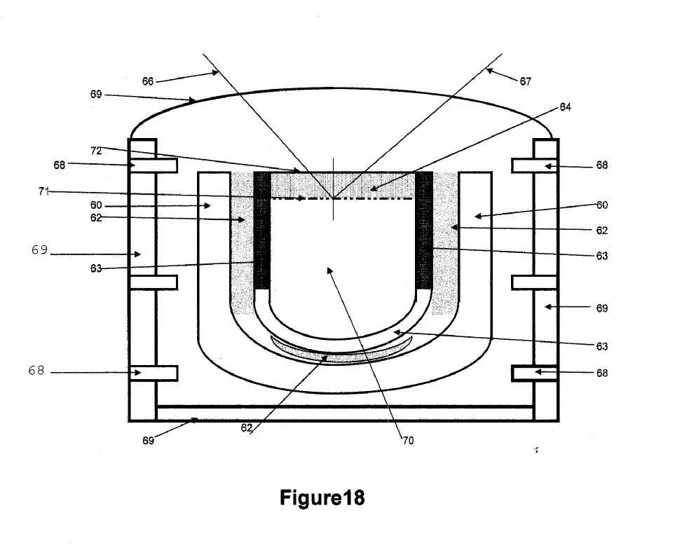

The remaining two glasses in Table 3.2, the Soda Lime Glass and the Special Soda Lime Glass are preferably formed and fused to the nuclear radioactive waste glass in a different, isothermal type method. This is preferred as shown in Table 3.3 with the approximate Melting temperature glass material properties of the soda lime/special soda lime glass and the preferred nuclear radioactive waste glass materials in Table 2.5 are within 10 to 100° C. of each other. However the glass material properties softening temperatures are 77 to 271° C. greater for the soda lime glasses as compared to the nuclear waste glasses. Because of this and the desire to avoid any thermal shock, cracking or separation for the soda lime and nuclear waste glasses the fabrication process preferably has a near isothermal temperature for these glasses. FIG. 18 shows a preferred embodiment for preferred one layer not fused embodiments A1, A2, A3, A4, A5, A6, A7, A8, A9, A10, B1, B2, C1 and C2 where the layer four material is Soda lime glass/special soda lime glass and the layer five material is the vitrified nuclear waste glass. FIG. 18 does not show the layer one or layer two enclosures it just shows the layer three and layer four materials being fused together.

FIG. 18 is similar to FIGS. 14, 17 and 5 and illustrates the use of lower melting temperature(≦1200° C.) glasses in the preferred one layer not fused embodiments. FIG. 18 shows a sectional view of a containment system with outermost exterior containment layer (60), innermost waste adjacent interior containment layer (63) and melted radioactive glass material (70) in a furnace (69) fusing the radioactive nuclear waste glass (70) to the innermost waste adjacent interior containment layer (63) which is comprised of soda lime glass/special soda lime glass. In FIG. 18, outermost exterior containment layer (60) is preferably a exterior molding layer, and preferably is a metal tubular layer or metal enclosure which acts as an enclosing mold and in a preferred embodiment would be stainless steel metal material. Particulate sand or high temperature frit glass particles (62) packed in and shaped to the inside surface of the containment system outermost exterior containment layer metal enclosure (60) to the preferred height (72) as shown. Then a soda lime glass/special soda lime glass innermost waste adjacent interior containment layer (63) comprised of soda lime glass/special soda lime glass material in the shape of a tubular member is disposed therein. Next the hot glass laser level measurement as previously described utilizes incoming beam (66) and outgoing beam (67) to bring previously melted and vitrified nuclear waste glass material (70) to the predetermined level point (71) as shown. Previously the metal mold outermost exterior containment layer (60) and soda lime glass/special soda lime glass innermost waste adjacent interior containment layer (63) are preheated to within a few degrees C. of the pouring/working temperature of the nuclear radioactive waste glass material (70). This temperature is estimated at 650-750° C. and proximate the softening temperature of the soda lime glass/special soda lime glass. This temperature is also well above the strain temperature point for both glasses. Next molten soda lime/special soda lime glass (64) is formed and stream/gobbled fed to the desired level point (72). As an alternative to conventionally melting and stream/gob feeding such glass, as previously described in FIGS. 12 and 13 a soda lime/special soda lime frit glass may be provided and heated. The whole containment system enclosures including the lids are first held to an equilibrium temperature just a few degree above the original pouring/gobing temperature of the nuclear radioactive waste glass (70). Then the containment system total enclosure is very slowly cooled through the fused and strain temperature point of the glasses resulting in a containment system fused two or three layer enclosure (60), (63) and (70) with the respective lids (64) of the layer three material. Once the containment system total enclosure has reached ambient atmospheric conditions the two layer enclosed innermost waste adjacent interior containment layer (63) and the radioactive waste glass material (70) with the glass material lid (64) could be removed from the layer three metal tube/mold (60) or it could remain in place as an extra abrasion protection. Preferably the radioactive waste glass material (70) is provided by melting in a furnace and its glass melt temperature is then cooled to approximately 650-750° C. with a viscosity that permits it to be stream/gob fed into the innermost waste adjacent interior containment layer (63). The two layer enclosed innermost waste adjacent interior containment layer (63) and the radioactive waste glass material (70) with the glass material lid (64) or the two layer enclosed innermost waste adjacent interior containment layer (63) and the radioactive waste glass material (70) with the glass material lid (64) inside the metal mold outermost exterior containment layer (60) to make preferred embodiments A1, A2, A3, A4, A5, A6, A7, A8, A9, A10, B1, B2, C1 and C2 where the layer three/layer four material is Soda lime glass/special soda lime glass and the layer four/layer five material is the vitrified nuclear waste glass. This will provide a robust section of a four/five layer enclosures for the preferred embodiments with the preferred one layer not fused embodiments except that the soda lime/special soda lime glass is not as resistant to water or mineral migration in the unlikely event that moisture or minerals would ever penetrate the layer one/layer two of the preferred four/five layer embodiment with the preferred one layer not fused embodiments. Preferably an additional glass ceramic layer is added to the embodiment shown in FIG. 18 or by substituting a (high melting temperature ≧1300° C.) glass ceramic material in place of the metal mold when using soda lime glass/special soda lime glass fused to the vitrified nuclear waste glasses (70). The additional steps to completely seal a two layer lid to the two layer enclosure and to seal the indentation in layer one are the same as in preferred embodiments A1, A2, A3, A4, A5, A 6, A7, A8 and A9. The steps to anneal and test the completed enclosure are also the same as preferred embodiments A1, A2, A3, A4, A5, A6, A7, A8, and A9.

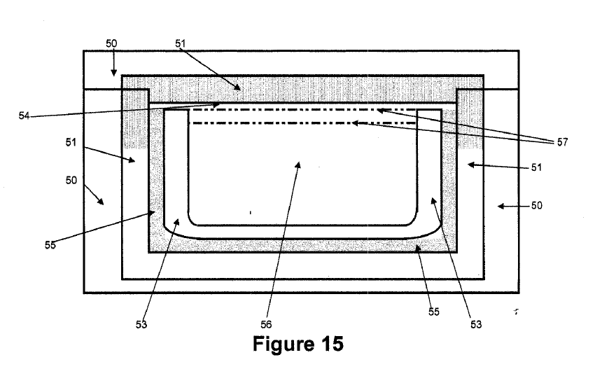

In a preferred embodiments of this invention FIG. 15 shows schematically a completed two layer enclosure containment system including its two layer lid. When completely made, filled, and sealed this may be referred to, as a complete four layer enclosure using the preferred one layer not fused embodiments.

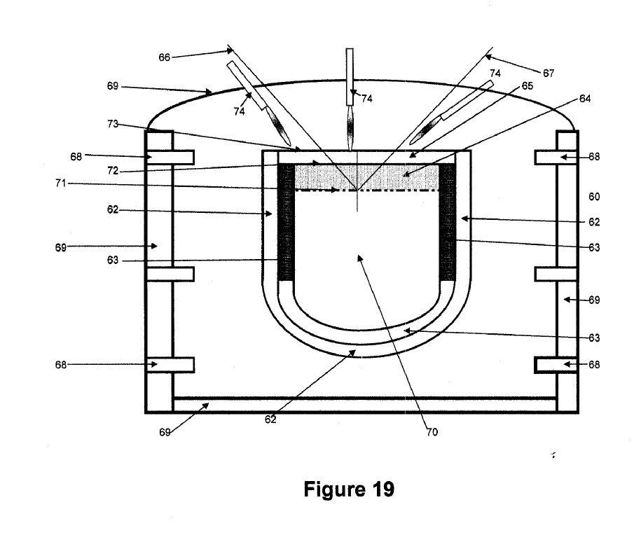

FIG. 19 illustrated a robust multilayer enclosure containment system using soda lime glass/special soda lime glass fused to the vitrified nuclear radioactive waste glasses. FIG. 19 is similar to FIGS. 14, 17, 18 and 5 and illustrates the use of lower melting temperature (≦1200° C.) glasses in the preferred one layer not fused embodiments. FIG. 19 shows a sectional view of a containment system in a furnace (69) fusing the nuclear radioactive waste glass (70) to the soda lime glass/special soda lime glass material innermost waste adjacent interior containment layer (63). In FIG. 19, outermost exterior containment layer (62) is preferably a glass ceramic tube enclosure comprised of an exterior containment layer glass material which acts as an outer mold and in a preferred embodiment would be medium expansion glass ceramic. Then a soda lime glass/special soda lime glass tube innermost waste adjacent interior containment layer (63) of the correct matching shape is disposed inside outermost exterior containment layer (62). Next the hot glass laser level measurement as previously described uses incoming beam (66) and outgoing beam (67) to bring previously melted and vitrified melted nuclear waste glass material (70) to the predetermined level point (71) as shown. Previously the glass ceramic layer mold outermost exterior containment layer (62) and soda lime glass/special soda lime glass innermost waste adjacent interior containment layer (63) are preheated to with in a few degrees ° C. of the pouring/working temperature of the nuclear radioactive waste glass (70). This temperature is estimated at 650-750° C. and proximate the softening temperature of soda lime glass/special soda lime glass. This temperature is also well above the strain temperature point for all materials in this embodiment. Next, using the laser level measurement as previously described, molten soda lime/special soda lime glass (64) or as previously described in FIGS. 12 and 13 soda lime/special soda lime frit glass is heated, formed and or stream/gob fed to the desired level point (72). Next, using the laser level measurement, molten medium expansion glass ceramic glass material (65) or as previously described in FIGS. 12 and 13 glass ceramic frit glass is heated, formed and or stream/gob fed to the desired level point (73). Then the glass ceramic would be heated by focus burners (74) to the desired nucleation and ceram temperature and is ceramed. Next the containment system whole enclosures including the lids are first held to an equilibrium temperature just a few degree above the original pouring/gobing temperature of the nuclear radioactive waste glass (70). Then the total enclosure is very slowly cooled through the fuse and strain temperature point of the glass/glass ceramic resulting in a fused three layer enclosure containment system with outermost exterior containment layer (62) and soda lime glass/special soda lime glass innermost waste adjacent interior containment layer (63) and radioactive waste glass (70). Preferably the vitrified nuclear radioactive waste glass (70) has been melted in a furnace and its temperature was reduced to approximately 650-750° C. to a viscosity that permits it to be stream/gob fed into the soda lime glass/special soda lime glass innermost waste adjacent interior containment layer (63). This fused three layer enclosure containment system with outermost exterior containment layer (62) and soda lime glass/special soda lime glass innermost waste adjacent interior containment layer (63) and radioactive waste glass (70) is then used as previously described to make preferred embodiments A1, A2, A3, A4, A5, A6, A7, A8, A9, A10, B1, B2, C1 and C3 where the layer four material is Soda lime glass/special soda lime glass and the layer five material is the vitrified nuclear waste glass. When this three layer enclosure is added to the two layer outer enclosure including the respective lid the containment system will be a robust five layer enclosures for the preferred embodiments with the preferred one layer not fused embodiments.

The additional steps to complete a preferred five layer enclosure and to seal the two layer lid and the indentation in layer one are the same as in preferred embodiments A1, A2, A3, A4, A5, A6, A7, A8 and A9. The steps to anneal and test the completed enclosure are also the same as preferred embodiments A1, A2, A3, A4, A5, A6, A7, A8, and A10 and have been explained in detail. In a preferred embodiment of this invention FIG. 15 shows schematically a completed two layer outer enclosure including its two layer lid. When completely made and filled with glass waste this can been referred to as a complete four layer enclosure using the preferred one layer not fused embodiments. In FIG. 15 outermost exterior containment layer one (50) is completely sealed along with adjacent interior containment layer two (51). FIG. 15 also shows innermost waste adjacent interior containment layer three (53) and the dotted line outline of its lid (57). Also shown the melted vitrified nuclear radioactive waste glass (56) is not attached to adjacent interior containment layer two (51) glass material of the lid because of the defined space (54) between the top of innermost waste adjacent interior containment layer three (53) and the top of the vitrified nuclear radioactive waste (56). This complete four layer enclosure will be quite strong and will be in uniform compression. In like manner a five layer enclosure is possible using the additional metal or glass ceramic mold layer as previously described to make preferred embodiments with the preferred one layer not fused embodiments. As in preferred embodiments A1, A2, A3, A4, A5, A6, A7, A8, A9 and A10 the completely sealed two layer enclosure would be annealed, tested and will retard moisture and other minerals from reaching the vitrified nuclear waste (56).

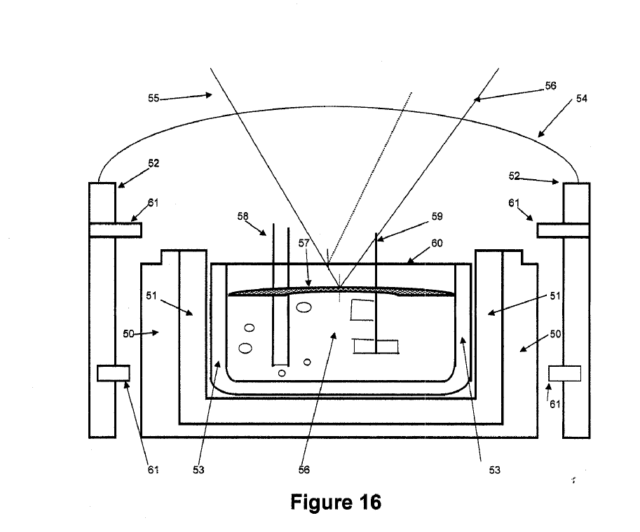

The preferred one layer not fused embodiments can also be used with high temperature metal materials. Table 3.2 shows some of the preferred metal materials for such layer three. These metals have a CTE from 5.7 to 11 ppm/at 560° K and Young's Modulus from 81 to 183 GPa. This combination of CTE and Young's Modulus does not matchup to the CTE and Young's Modulus of the vitrified nuclear radioactive waste glass. Table 2.5 shows the estimated average CTE of the preferred nuclear radioactive waste glasses as 8.1-9.9 ppm/° K at 560° K The historically two tested nuclear radioactive waste materials published, Borosilicate (BS WG) and Iron Phosphate (Fe S WG) Glass have a high relative CTE to most glass/glass ceramic materials and a low relative CTE to most metals. The two most notable exceptions are Zirconium metal material and Glasses with similar material specifications to Soda Lime Glass. As will be described using a stress model calculation the mismatch of CTE of most layer three metals to the CTE of the vitrified nuclear waste glass puts the layer three and layer four vitrified nuclear waste glass materials in somewhat high tension. As published, such is currently done when storing vitrified nuclear waste in metal containers. FIG. 16 is similar to FIG. 5 and illustrates the use of very high melting temperature metal material (≧1400° C.) in the preferred one layer not fused embodiments. FIG. 16 shows a sectional view of a containment system two layer outermost enclosure (50) and (51) in a furnace (52) melting the nuclear radioactive waste glass material (56) into a vitrified glass matrix glass material waste. In FIG. 16 the layer three innermost waste adjacent interior containment layer metal materials (53) are set inside the containment system two layer outermost enclosure (50) and (51). The furnace (52) is heated by an energy source preferably by Gas Oxygen burners (61) to a high enough temperature that it can melt the higher expansion, lower melting temperature (≦1200° C.) nuclear radioactive waste glass into a vitrified glass matrix waste glass material (56). Alternate Energy sources such as electric heating of the Glass matrix are possible. The Softening temperature of the outermost exterior containment layer one (50) glass material and the adjacent interior containment layer two (51) glass material are much higher than the melting temperature of the vitrified nuclear glass matrix so that the containment system two layer outermost enclosure and layer three do not significantly change shape or integrity during the heating. Preferably Bubbler (58) and mechanical stirrer (59) are used to help melt and increase the concentration of the nuclear waste into the glass matrix radioactive waste glass material (56). The incoming laser beam (55), which is the same schematically, as beam 43i in FIG. 4 is used to monitor the melted glass level (57) to a predefined point in order to leave space so that the layer three metal and layer four material vitrified nuclear waste glass do not contact the containment system outermost two layer lid when it is later sealed onto the containment system outermost two layer enclosure. In this design the previous layer five would not be used in order to avoid additional stress from layer four adhering (or sealing) to the underside of the two layer lid. In FIG. 16 the bubblers and stirrers are then removed. The additional steps to completely seal the containment system outermost two layer lid to the two layer enclosure and to seal the indentation in the outermost exterior containment layer one (50) are the same as in preferred embodiments A1, A2, A3, A4, A5, A6, A7, A8 and A9. The steps to anneal and test the completed enclosure are also the same as preferred embodiments A1, A2, A3, A4, A5, A6, A7, A8, A9 and A10 described.

In a preferred embodiment of this invention FIG. 15 shows schematically a complete outermost exterior containment system two layer enclosure including its outermost exterior containment system two layer lid. In FIG. 15 outermost exterior containment layer one (50) is completely sealed along with adjacent interior containment layer two (51). The figure also shows the innermost waste adjacent interior containment layer three (53) material not attached to adjacent interior containment layer two (51). using the previously described preferably the fine sand/frit (53). In other embodiments using glass materials as innermost waste adjacent interior containment layer three material (53), FIG. 15 shows the edges (57) of the fused lid for such layer three materials. FIG. 15 also shows the defined open space (54) below the lid layer adjacent interior containment layer two (51) and the top of layer three (53) and the top of the vitrified nuclear waste (56). The containment system outermost exterior containment layer one (50) with adjacent interior containment layer two (51) will be in uniform compression and provide a strong containment system. This containment system outermost exterior containment layer one (50) with adjacent interior containment layer two (51) two layer enclosure can also be referred to as a four layer enclosure using the preferred one layer not fused embodiments. Such preferred one layer not fused embodiments using high temperature metal as the not fused layer will have a disadvantage (with the exception of Zirconium metal material) since the not fused material (layer three, metal) and the vitrified nuclear waste glass (layer four) will be in tension. As in preferred embodiments A1, A2, A3, A4, A5, A7, A8, A9 and A10 the completely sealed two layer enclosure will be annealed, tested and will retard moisture and other minerals from reaching the vitrified nuclear waste.

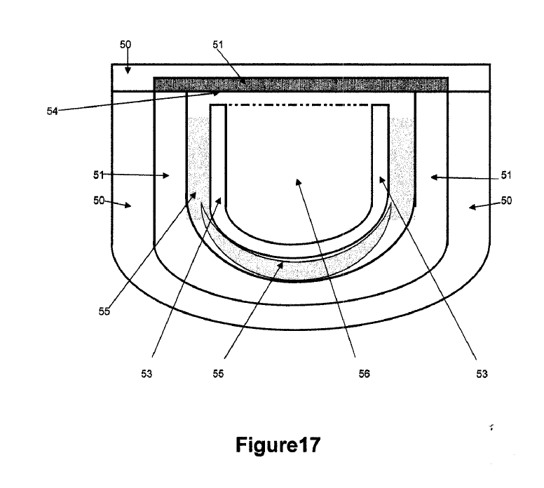

The preferred one layer not fused embodiments can be used with any of the preferred embodiments. As an example FIG. 17 is similar to FIG. 10 illustrating preferred embodiments B1 with a cylindrically shaped cross section. In this FIG. 17 containment system outermost exterior containment layer one (50) is a glass material such as commercially available Corning ULE glass and it is fused to adjacent interior containment layer two (51) which is a commercially available fused silica tube comprised of fused silica glass material. Also in FIG. 17 innermost waste adjacent interior containment layer three (53) is a preferably comprised of a commercially available fused silica glass material tube inserted adjacent to particulate matter frit/fine round silica sand (55). In a preferred embodiment of this invention FIG. 17 shows schematically a completed four layer enclosure including its containment system outermost exterior two layer lid with containment system outermost exterior containment layer one (50) and adjacent interior containment layer two (51). In FIG. 17 layer one (50) is completely sealed along with layer two (51). The figure also shows innermost waste adjacent interior containment layer three (53) not attached to layer two (51) and with the defined empty void space (54) above the top of layer three (53) and the top of the vitrified nuclear waste glass (56). This complete four layer enclosure will be quite strong and will be in uniform compression. This completed enclosure can also be referred to as a four layer enclosure using the preferred one layer not fused embodiments. The completely sealed two layer enclosure will be annealed, tested and will retard moisture and other minerals from reaching the vitrified nuclear waste glass.

A stress model has been used to evaluate the preferred one layer not fused and the other preferred embodiments for the best estimate of the stress between the material layers of the preferred embodiments. The model is based on a scientific analysis of the stress in glass butt seals. The analysis allows an initial evaluation of the stress between layers of glass/glass ceramic/metal fused together. The analysis uses the material physical constant CTE and Young's Modulus along with an estimate of the difference in temperature between the two materials as the stress is setup. The physical constants for the materials in this invention are known or can be estimated. The difference in temperature between the layers of material when the stress is setup has been estimated at 100° C. The stress calculations in Table 7 are also done for the two published vitrified nuclear waste Glasses, Iron Phosphate (Fe P) Waste Glass (WG) and Borosilicate (BS) Waste Glass (WG). The normal convention for stress is used where tension stress are positive (+) and compression stresses are negative (−).

The results of the preliminary stress model calculations are shown in Tables 7-10. It is noted that the absolute levels are approximations and that the relative differences and comparisons are particularly useful. Table 7 shows pictorially the results of the preferred embodiments using three/four layer enclosures (not including the lid) with the preferred all layers fused together embodiments. Areas that are in compression and tension stresses are indicated The stress levels and the Joint Figure of Merit (JFOM) for Iron Phosphate (Fe P) Waste Glass are listed as Fe P or Fe P WG. The stress levels and the Joint Figure of Merit (JFOM) for Borosilicate (BS) Waste Glass are listed as BS or BS WG. The Table shows the material for each layer, the calculated compressive stress for each layer, the calculated tension stress for the joints, along with a Figure of Merit (JFOM), for the joints in tension stress. The calculated figure of merit for joints (JFOM) that are in tension between the compression layers is preferably the Modulus of Rupture for the weaker layer material of the joint divided by the maximum tension stress calculated for the joint. This figure of merit (JFOM) is preferred because glass and glass ceramic materials preferably only fail in tension so the higher the numeric value for this figure of merit the less likely the material will ever crack, fail, or separate. The orders of the individual preferred embodiments within a table are listed in approximate total joint decreasing order of this figure of merit (JFOM). The preferred embodiments in Table 7 have beneficial results because, as an example, the preferred embodiments A9 using vitrified Iron Phosphate (Fe P) Waste Glass (WG) has the JFOM for the ratio of the layer one to layer two joint at 11.4 to 1. Table 7 also shows for preferred embodiments A9 that the stress in layer one is at a relatively low level of −3.4 M Pa. This means that the buildup in tension stress between layer one and two for preferred embodiments A9 is about 8.8% of the modulus of rupture level for the joints weakest materials. Also in Table 7 for the preferred embodiments A9 using vitrified Borosilicate (BS) Waste Glass (WG) has the JFOM for the ratio of the layer one to layer two joint at 25 to 1. Similarly in Table 7 the JFOM for the ratio of the layer two to layer three joint at 6.8 to 1 using vitrified Iron Phosphate (Fe P) Waste Glass (WG) and 15 to 1 using vitrified Borosilicate (BS) Waste Glass (WG). It is believed that the higher the ratio the more preferred and the estimated minimum level would be on the order of 1.5/1. A 1/1 level means that the tension stress is equal to the material's modulus of rupture, so the material is most likely to fail, separate or crack sometime even without additional external force. Another preferred embodiments A8 in Table 7 using vitrified Iron Phosphate (Fe P) Waste Glass (WG) also has beneficial results because the JFOM ratio for layer one to layer two is 14.1 to 1 and the preferred material in layer one (Medium Expansion Glass Ceramic) preferably has high strength in compression. Also in preferred embodiments A8 in Table 7 the JFOM for the ratio of the layer two to layer three joint at 8.5 to 1 using vitrified Iron Phosphate (Fe P) Waste Glass (WG). In preferred embodiments A8 in Table 7 the results using vitrified Borosilicate (BS) Waste Glass (WG) are not desired and are not shown because in this embodiment layer two and layer three would be tension. Since the total enclosure including the lid and vitrified nuclear waste glass are in compression it is believed that the layers add strength to each other, although the outer layer is the most critical in intrinsic strength. Table 7 also shows other preferred embodiments A1, A2, A3, A4, A5, A6, A7, A10, B1, B2, C1, and C2 with three/four layer preferably all layers fused together embodiments with Iron Phosphate (Fe P) and Borosilicate (BS) Waste Glass (WG).

Table 8 is organized in the same manner as Table 7. Table 8 is for preferred embodiments of the preferred all layers fused together embodiments, with a layer of material (layer three) making the CTE transition to the vitrified nuclear waste glass less severe. This will result in a four or five layer enclosure (less its lid). In the preferred embodiments of Table 8 the layer three materials is Magnesium Aluminosilicate Glass/Soda Lime glass/Special Soda Lime Glass/Medium Expansion Glass Ceramic. This is selected because the preferred materials in Layer three of Table 8 have a CTE at 560° K of approximately 2.0 to 8.8 ppm/° K and a relatively high Young's Modulus from 60 to 94 G Pa. This helps to reduce the stress between layers two and layer four, the vitrified nuclear waste glass which has a average CTE of approximately 8.8 to 10 ppm/° K and a Young's Modulus from 75 to 82 G Pa. In this Table 8 the largest difference in CTE between any fused layers is 8 ppm/° K. One preferred result for this Table 8 in comparison to Table 7 using vitrified Iron Phosphate (Fe P) Waste Glass is that the average stresses in Table 8 are 37% less than the average stresses in Table 7. Also in Table 8 preferred embodiments C1 has excellent results since the JFOM ratio of the tension stress in all layer ranges from 4.3 to 7.3 and the CTE differences between the layer is smaller and is +2.4, +3.2 and +2.2 respectively. This more gradual difference between the fused layers is a preferred embodiment of this invention. Table 8 also shows other preferred embodiments A1, A3, A5, A7, B1, B2 and C2 with three/four layer preferably all layers fused together embodiments with Iron Phosphate (Fe P) and Borosilicate (BS) Waste Glass (WG).

Table 9 is organized similar to Table 7 and 8. Table 9 is for four of the preferred embodiments in Table 8 but for the preferred one layer not fused embodiments with Stainless Steel and Zirconium metal as the not fused layer three. This Table is also using a four layer enclosure where the layer three materials is a metal. First the JFOM ratio for the preferred embodiments B2 is estimated at 149 to 1 for layer one to two. That means that the tension stress between layer one (Low Expansion Glass Ceramic) and layer two (Fused Silica Glass) is about 0.67% of the estimated Modulus of Rupture of the weakest material of the joint. These preferred embodiments in Table 9 have a high JFOM for Layer one to layer two because the CTE difference between the layers is ≦0.52 ppm/° C. and the Young's Modulus values permit the desired stresses. In addition the stress from Layer three to Layer four (the vitrified nuclear waste glass) have been decoupled from the first two layers because of the one layer (layer three) not fused. The disadvantages of the high temperature stainless steel metal is that the not fused layer three metal and layer four, the vitrified nuclear waste glass are in tension stress. As predicated by the model, the nuclear waste glass has tension stress 1.1 times the estimated modulus of rupture of the vitrified Iron Phosphate (Fe P) Waste Glass. This is not preferred because even though the probability of any water or mineral penetration through layers one or two is very low, if that were to happen it would be easier to erode the vitrified nuclear waste glass, if it was already cracked and broken up in pieces with a high surface area. The one exception that has been studied is that Zirconium metal has CTE and Young's modulus values that permit the nuclear waste glass to be in compression. A potentially disadvantage of Zirconium metal as the layer three material is that it is expensive.

Table 10 shows preferred results and is organized similar to Table 7, 8 and 9. Table 10 illustrates two of the preferred embodiments in Tables 7 and 8 but for the preferred one layer not fused embodiments with Glass/Glass Ceramic Materials as the preferred not fused material. This Table 10 is also for a four (or five) layer enclosure. In like manner any of the preferred embodiments A1, A2, A3, A4, A6, A7, A8, A9, A10, B1, C1 and C2 could be matched up with a four/five layer enclosure with the preferred one layer not fused embodiments using the Glass/Glass Ceramic materials for layer three and layer four as shown in Table 10. This illustrated Table 10 also has some significant benefits. First the proposed JFOM ratio for the preferred embodiments B2 is 149 to 1, the same as Table 9. This means that the tension stress between layer one (Low Expansion Glass Ceramic) and layer two (Fused Silica Glass) is about 0.67% of the Modulus of Rupture of the weakest material. A preferably significant advantage is that layer three and layer four (the Not fused material and the vitrified nuclear waste) are in compression. The other preferred embodiments in Table 10 also have high JFOM ratios for the layer one and layer two fused joints. A preferably significant advantage is that the JFOM for the layer three to layer four (vitrified Iron Phosphate (Fe P) Waste Glass) joint in Table 10 is on average 300% higher than the same material joints in Table 8. These high values for the JFOM ratio of layer one to two and layer three to four are preferred and demonstrate a very high strength sealed (including the lids) four/five layer enclosures. This high strength enclosure made of glass/glass ceramic materials is preferably ideal for storing and protecting vitrified nuclear waste glass.

With the perceived low levels of stress between Layer one and two for some of the preferred embodiments the compressive stress can be increased. This can be done by using a faster cool down cycle resulting in a higher temperature difference in the layers while the stress is being set up. When the stress can start at a low level from a design point of view it can always be increased by adjusting the cooling rate while the fused layers are being set up. Care must be taken to insure that the proposed Joint Figure of Merit (JFOM) stays at a high level even though the tension stress of the joint increases with a faster cooling rate.

In an embodiment the invention preferably includes a method of making a radioactive waste containment system with a multilayer enclosure of Glass/Glass Ceramic materials that is in-compression for storing nuclear waste.

A preferred embodiment of this radioactive waste containment system with a multilayer enclosure that has near defect free material in contact with the inside surfaces of the fused layers in tension resulting in a very high strength in-compression vessel that is used to store nuclear waste. The preferred quality level for the near defect free material is ≦2.0 mm² total inclusion cross section in 100 cm³ of material when the maximum size is ≦0.1 mm. In addition the surfaces to be fused together is preferably free of any visible defect (gaseous or solid inclusions, foreign material or particles).

In an embodiment the invention preferably includes a method of making a radioactive waste containment system with multilayer enclosure where the product of the coefficient of linear expansion (CTE) and Young's modulus is increased with each attaching fused layer resulting in an ultra-high strength in-compression enclosure. An additional preferred embodiment where the CTE is increased in two or more steps and where the difference in the CTE between the attached layers is equal to or less than 13 PPM/° K resulting in an in-compression enclosure. An additional preferred embodiment where the CTE is increased in two or more steps and where the difference in the CTE between the attached layers is equal to or less than 6 PPM/° K resulting in an in-compression enclosure with minimal compressive and tension stresses. Further preferred embodiments of this invention where the compression and tensions stress are adjusted higher than a minimal level by increasing the cooling rate while the fused layer are being set up. A further preferred embodiment where the CTE is increased in two or more steps where the difference in the CTE between the layers is equal to or less than 3.2 PPM/° K. A further preferred embodiment where the compression and tensions stress are at a minimal level to ensure that the tension stress between the two most outer layers is not more than about 0.21% of the compressive layers materials Modulus of Rupture. A further preferred embodiment where the compression and tensions stress are at a level to ensure that the tension stress between the two most outer layers is not more than about 0.72% of the compressive layers materials Modulus of Rupture. Further preferred embodiments where the compression and tensions stress are adjusted higher than a minimal level by increasing the cooling rate while the fused layer are being set up. A further preferred embodiment where all layers fused together have greater than four layers fused together to fabricate an enclosure or vessel that is used to store nuclear waste.

In an embodiment the invention preferably includes a method of making a two to six layer enclosure radioactive waste containment system where the melting temperature of the Glass, Glass Ceramic/metal layers are adjusted in each subsequent layer permitting melted/fused contact of the layers resulting in a buildup of a dimensionally stable high strength in-compression enclosure.

In an embodiment the invention preferably includes a method of using a Laser level measurement to adjust the volume of the nuclear waste material in its glass state to a predetermined point.

In an embodiment the invention preferably includes a method of using a laser level measurement and a controlled volume extension of the lid to adjust a layer of material in its molten state so that it makes uniform contact with the bottom surface of the lid resulting in a void free and uniform in-compression enclosure. An additional preferred embodiment where the layer that seals to the lid is a glass with CTE and Young's Modulus similarly to Soda Lime Glass. An additional preferred embodiment where the layer that is sealed to the lid is a glass/glass ceramic material where the CTE of that material closely matches the CTE of the vitrified nuclear waste glass resulting in a difference in CTE match up of ≦3 ppm/° K.

In an embodiment of the invention preferably includes a method of using the laser level measurement in the high temperature melting environment of the nuclear waste verification.

In an embodiment where all layer are fused together the invention preferably includes a method of using a controlled volume of the Lid's last compressive layer material to move the minimal atmospheric void of the Lid's sealing to an adjacent layer to increase the uniformity and strength of the Multilayer enclosure.

In an embodiment the invention preferably includes a method of using the laser level measurement to test that the two/three outer layers that are fused together in a multilayer enclosure including its lid have molten material surface “melted” fused contact with each other.

In an embodiment where all layers are fused together the invention preferably includes a method of shaping, fitting and measuring the enclosure's outer lid before the final melting and sealing of the enclosure resulting in a uniform in-compression enclosure.

In an embodiment where all layers are fused together the invention preferably includes a method of using a last layer of glassy material that is closely matched to the CTE of the vitrified nuclear waste glass to increase the uniformity and strength of the multilayer enclosure.

In an embodiment the invention preferably includes a method of using commercially available Glass/Glass Ceramic Tubes that can be converted into two, three, four, five, or six layer enclosure or vessels for storing nuclear waste.

In an embodiment the invention preferably includes a method of over cladding the commercially available Glass/Glass Cermanic Tubes with the same composition as the tube to seal any potentially defects and to move the defects out of a eventual tension area prior to adding the adjacent layer for the multi-layer enclosure.

In an embodiment the invention preferably includes a method of sealing the outer layers (including the lid) of the multilayer enclosure containment system with glass materials that generate an in-compression layer that also retards water or minerals from reaching the inner most layers. An additional preferred embodiment where multilayers of Glass/Glass Ceramic Materials are used to retard water or minerals from reaching the inner most layers. An additional preferred embodiment where the sealing of the outer layer uses a matching material where the CTE is made lower by adjusting the composition of the material resulting in a higher in-compression seal.

In an embodiment the invention preferably includes a method of making a containment system multilayer lid to build a uniform in-compression enclosure. An additional preferred embodiment where a multilayer lid is made in place or melted on top of the vitrified nuclear waste to build a uniform and water resident in-compression enclosure or vessel. An additional preferred embodiment where the lid that is made in place is of a glass/glass ceramic composition that is matched to the vitrified nuclear waste glasses CTE.

In an embodiment the invention preferably includes a method of melting and vitrifying nuclear waste in a multilayer enclosure of high temperature Glass, Glass Ceramic and or metal that also become the storage enclosure containment system for the nuclear radioactive waste.

A preferred embodiment of this invention includes making a containment system with a multilayer enclosure with near defect free material in contact with the inside surfaces of the fused layers where the layer of material attached to or adjacent to the nuclear waste glass is not fused to the two/three layer enclosure in compression. The preferred quality level for the near defect free material is ≦2.0 mm² total inclusion cross section in 100 cm³ of material when the maximum size is ≦0.1 mm. An additional preferred embodiment where the compression and tensions stress are at a minimal level to ensure that the tension stress between the two/three most outer layers is not more than about 0.21% of the compressive layers materials Modulus of Rupture. Further preferred embodiments of this invention where the compression and tensions stress are adjusted higher than a minimal level by increasing the cooling rate while the fused layer are being set up. A further preferred embodiment of this invention where the attaching layer, attached to the vitrified nuclear waste glass, is lower in CTE than the CTE of the nuclear waste glass by ≦6 PPM/° K.

A further preferred embodiments of this invention includes making a containment system with material layers where the product of the Young's Modulus and CTE of the innermost waste adjacent interior containment layer attached to the vitrified nuclear radioactive waste glass results in the attached layers being in-compression. A further preferred embodiments of this invention includes making a containment system with material layers where the products of the Young's Modulus, CTE and fused temperature differences of the innermost waste adjacent interior containment layer attached to the vitrified nuclear radioactive waste glass results in the attached layers being in-compression.

The following accompanying Tables are included to provide a further understanding of the invention, and are incorporated in and constitute a part of this specification.

TABLE 1
Preferred Layer One Materials

| | CTE | CTE | | |
|---|---|---|---|---|
| | ppm/° K | ppm/° K | | Trade |
| Materials | @ 300° K | @ 560° K | Manufacture | Name |
| Fused Silica | 0.5 | 0.55 | Schott | Lithosil ® |
| Glass | | | | |
| Fused Silica | 0.59 | 0.59 | Heraeus | Suprasil ® |
| Glass | | | Amersil | |
| Fused Silica | 0.52 | 0.57 | Corning | HPFS ® |
| Glass | | | | |
| Ultra Low | 0 ± 0.03 | 0.05 | Corning | ULE ® |
| Expansion | | | | |
| Glass | | | | |
| Ultra low | 0 ± 0.1 | 0.38 | Schott | 200Zerodur ® |
| Expansion | | | | |
| Glass | | | | |
| Ceramic | | | | |
| Borosilicate | 3.25 | 3.25 | Schott | Supermax ®33 |
| Glass | | | | |
| Borosilicate | 3.25 | 3.25 | Corning | Pyrex ®7740 |
| Glass | | | | |
| Low | 0.3 | 0.32 | Corning | Pyroceram ®9963 |
| Expansion | | | | |
| Glass | | | | |
| Ceramic | | | | |
| Medium | 5.7 | 5.7 | Corning | Pyroceram ®9606 |
| Expansion | | | | |
| Glass | | | | |
| Ceramic | | | | |

TABLE 2
Preferred Layer Two Materials

| | CTE | CTE | | |
|---|---|---|---|---|
| | ppm/ | ppm/ | | |
| | ° K @ | ° K @ | | Trade |
| Materials | 300° K | 560° K | Manufacture | Name |
| Borosilicate | 3.25 | 3.25 | Schott | Supermax ®33 |
| Glass | | | | |
| Soda Lime Glass | 8.8 | 8.8 | Wheaton | Type III Code 800 |
| Borosilicate | 3.25 | 3.25 | Corning | Pyrex ®7740 |
| Glass | | | | |
| Fused Silica | 0.5 | 0.55 | Schott | Lithosil ® |
| Glass | | | | |
| Fused Silica | 0.52 | 0.57 | Corning | HPFS ® |
| Glass | | | | |
| Special Soda | 8.4 | 8.4 | Unknown | Preferred |
| Lime Glass | | | | Composition |
| | | | | 13.4% |
| | | | | Na2O + K2O, |
| | | | | 10% |
| | | | | CaO + MgO, |
| | | | | 4.2% ZnO, 2% |
| | | | | AL2O3, |
| | | | | 0.347% BaO + |
| | | | | Fe2O2 70% SiO2 |
| Alkali Barium | 8.9 | 8.9 | Corning | Code 9013 ® |
| Glass | | | | |
| Zinc Borosilicate | 7.4 | 7.4 | Corning | Code 0211 ® |
| glass | | | | |
| Magnesium | 2.02 | 2.02 | Unknown | Preferred |
| | | | | Composition |
| Aluminosilicate | | | | 5.42% MgO |
| Glass | | | | 13.72% AL2O3 |
| | | | | 80.86% SiO2 |
| Germanium | 0.7-2.0 | 0.7-2.0 | Unknown | Preferred |
| | | | | Composition |
| Oxide Silicate | | | | 2-14% GeO2, |
| Glass | | | | 98-86% SiO |
| Low Expansion | 0.3 | 0.32 | Corning | Pyroceram ®9963 |
| Glass Ceramic | | | | |
| Medium | 5.7 | 5.7 | Corning | Pyroceram ®9606 |
| Expansion Glass | | | | |
| Ceramic | | | | |

TABLE 2.5
Preferred Nuclear Waste Glass Material Properties

| | Estimated | Estimated | Approximate | |
|---|---|---|---|---|
| | Young's | Modulus | Melting | |
| | Modulus | of Rupture | Temperature/ | |
| Preferred | at 300° K | at 300° K | Softening | |
| Materials | G Pa | M Pa | Temperature ° C. | Comment |
| Borosilicate | 82 | 50 | 1050/550 | From one |
| Waste Glass | | | | Reference |
| (BS WG) | | | | |
| Iron Phosphate | 75.6 | 50 | 1160/650 | Average |
| Waste Glass | | | | from two |
| (Fe P WG) | | | | References |

TABLE 3.1
Preferred Layer Three Materials When Layer
Three is Fused to Layer two

| | | | |
|---|---|---|---|
| | | Approx- | |
| | CTE | imate | |
| | ppm/ | Melting | |
| | ° K | Temper- | |
| | @ | ature | |
| Preferred Materials | 560° K | ° C. | Comment |

Glass Melting Materials:

| | | | |
|---|---|---|---|
| Magnesium | 2.0 | ≧1300 | Preferred Composition |
| Aluminosilicate Glass | | | 5.42.% MgO, 13.72% |
| | | | AL2O3, 80.86% SiO2 |
| Cesium Aluminosilicate | 2.28 | ≧1300 | Preferred Composition |
| Glass | | | 5% Cs2O, 5% AL2O3, |
| | | | 90% SiO2 |
| Alumina Titanium | 2.0 | ≧1300 | Preferred Composition |
| Silicate Glass | | | 27.5% AL2O3, 23.7 |
| | | | Tio2, 48.8% SiO2 |
| Lead Borosilicate | 2.1 | ≧1300 | Preferred Composition |
| Glass | | | 10% PbO, 9.7% B2O3, |
| | | | 80.3% SiO2 |
| Medium Expansion Glass | 5.7 | ≧1450 | Corning |
| Ceramic | | | Pyroceram ®9606 |
| Alkali Barium Glass | 8.9 | TBD | Corning Code 9013 ® |
| Zinc Borosilicate glass | 7.4 | TBD | Corning Code 0211 ® |
| Soda Lime Glass | 8.8 | ≧1150 | Wheaton |
| (note Young's | | | Type III Code 800 |
| Modulus is 72 G Pa) | | | |
| Special Soda Lime | 8.4 | ≧1150 | Preferred Composition |
| Glass | | | 13.4% Na2O + K2O, |
| (note Young's | | | 10% CaO + MgO, 4.2% |
| Modulus is 72 G Pa) | | | ZnO, 2% AL2O3, |
| | | | 0.347% BaO + Fe2O2 |
| | | | 70% SiO2 |
| Borosilicate Waste | 8.1^{a} | ≧1050 | Not Commercially |
| Glass (BS WG) | | | Available |
| Iron Phosphate Waste | 8.8^{b} | ≧1160 | Not Commercially |
| Glass (Fe P WG) | | | Available |

^{a}CTE from one reference
^{b}Average from many Glasses from two references
Note:
Estimated Young's Modulus for these Glasses unless noted is 60 G Pa and Estimated Modulus of Rupture (MOR) is 50 M Pa

TABLE 4
Layer One and Two Expansion Matching for In-Compression at 560° K
With Preferred Embodiments A1 to A7

| | | Layer 1 | | | | Layer 2 | |
|---|---|---|---|---|---|---|---|
| | | Approximate | | | | Approximate | |
| | | Melting | | | | Melting | |
| | | Temperature/ | | | | Temperature/ | Preferred |
| | | Softening | Layer 1 | | Layer 1 | Softening | Delta |
| | Layer 1 | Temperature | CTE | Layer 2 | CTE | Temperature | CTE |
| Embodiments | Material | ° C. | ppm/° K | Material | ppm/° K | ° C. | ppm/° K |
| A1 | Fused Silica | ≧2000/1585 | 0.50-0.59 | Borosilicate | 3.25-3.3 | ≧1300/825 | +2.7-+2.8 |
| | Glass | | | Glass | | | |
| A2 | Ultra low | ≧1900/1490 | 0.05 | Borosilicate | 3.25-3.3 | ≧1300/825 | +3.2 |
| | Expansion | | | Glass | | | |
| | Glass | | | | | | |
| A3 | Ultra low | ≦1900/1490 | 0.05 | Low Expansion | 0.38 | ≧1400/1350 | +.33 |
| | Expansion | | | Glass Ceramic | | | |
| | Glass | | | | | | |
| A4 | Fused Silica | ≧2000/1585 | 0.50-0.59 | Magnesium | 2 | ≧1300/≦1250 | +1.4-+1.5 |
| | Glass | | | Aluminosilicate | | | |
| | | | | Glass | | | |
| A5 | Fused Silica | ≧2000/1585 | 0.50-0.59 | Germanium | 0.7-2.0 | ≧1300/≦1500 | +0.11-+1.5 |
| | Glass | | | Oxide Silicate | | | |
| | | | | Glass | | | |
| A6 | Ultra low | ≦1900/1490 | 0.05 | Magnesium | 2 | ≧1300/≦1250 | +1.95 |
| | Expansion | | | Aluminosilicate | | | |
| | Glass | | | Glass | | | |
| A8 | Medium | ≧1450/1350 | 5.7 | Soda Lime Glass | 8.4-8.8 | ≧1150/821 | +2.7-+3.1 |
| | Expansion | | | | | | |
| | Glass | | | | | | |
| | Ceramic | | | | | | |
| A9 | Medium | ≧1450/1350 | 5.7 | Special | 8.4-8.8 | ≧1150/821 | +2.7-+3.1 |
| | Expansion | | | Soda Lime Glass | | | |
| | Glass | | | | | | |
| | Ceramic | | | | | | |
| A10 | Borosilicate | ≧1300/825 | 3.25-3.3 | Soda Lime Glass | 8.4-8.8 | 1177/821 | +5.1-+5.55 |
| | Glass | | | | | | |

TABLE 5
Layer One and Two Expansion Matching for In-Compression at 560° K
With Preferred Embodiments B1 and B2

| | | Layer 1 | | | | Layer 2 | |
|---|---|---|---|---|---|---|---|
| | | Approximate | | | | Approximate | |
| | | Melting | | | | Melting | |
| | | Temperature/ | | | | Temperature/ | Preferred |
| | | Softening | Layer 1 | | Layer 1 | Softening | Delta |
| | Layer 1 | Temperature | CTE | Layer 2 | CTE | Temperature | CTE |
| Embodiments | Material | ° C. | ppm/° K | Material | ppm/° K | ° C. | ppm/° K |
| B1 | Ultra low | ≦1900/1490 | 0.05 | Fused Silica | 0.50-0.59 | ≧2000/1585 | +0.45-+0.54 |
| | Expansion | | | Glass | | | |
| | Glass | | | | | | |
| B2 | Low | ≧1400/1350 | 0.32-0.38 | Fused Silica | 0.50-0.59 | ≧2000/1585 | +1.2-+2.1 |
| | Expansion | | | Glass | | | |
| | Glass Ceramic | | | | | | |

TABLE 6
Layer one and two Expansion Matching for In-Compression at 560° K
With Preferred Embodiments C1 and C2

| | | Layer 1 | | | | Layer 2 | |
|---|---|---|---|---|---|---|---|
| | | Approximate | | | | Approximate | |
| | | Melting | | | | Melting | |
| | | Temperature/ | | | | Temperature/ | Preferred |
| | | Softening | Layer 1 | | Layer 1 | Softening | Delta |
| | Layer 1 | Temperature | CTE | Layer 2 | CTE | Temperature | CTE |
| Embodiment | Material | ° C. | ppm/° K | Material | ppm/° K | ° C. | ppm/° K |
| C1 | Borosilicate | ≧1300/825 | 3.25-3.3 | Medium | 5.7 | ≧1450/1350 | +2.4-+2.45 |
| | Glass | | | Expansion | | | |
| | | | | Glass Ceramic | | | |
| C2 | Low | ≧1400/1350 | 0.38 | Medium | 5.7 | ≧1450/1350 | +5.32 |
| | Expansion | | | Expansion | | | |
| | Glass Ceramic | | | Glass Ceramic | | | |

TABLE 8
Estimated Stress performance of five embodiments with a four/five layer all layer fused together embodiments
with Iron Phosphate (Fe P) and Borosilicate (BS) Waste Glass (WG)

| | | | | | | | | Tension | | Layer Four | |
|---|---|---|---|---|---|---|---|---|---|---|---|
| | | Tension | | | Tension | | | Ratio of | | Vitrified | |
| | | Ratio of | | | Ratio of | | | Joint Min | | Nuclear | |
| | Layer One | Joint | | Layer Two | Joint Min | | Layer Three | MOR/ | | Waste | |
| | Compression | Min MOR/ | | Compression | MOR/Max | | Compression | Max | | Compression | |
| | M Pa | Max Stress | | M Pa | Stress | | M Pa | Stress | | M Pa | |
| A5 | Fused Silica | Fe P | BS | Germanium Oxide | Fe P | BS | Magnesium | Fe P | BS | Fe P | BS |
| | Glass | 18 | 18 | Silicate Glass | 1.6 | 1.8 | Aluminosilicate | 1.6 | 1.8 | −31.5 | −27.2 |
| | Compressive | | | Compressive Stress | | | Glass | | | | |
| | Stress −1.2 | | | −2.8 | | | Compressive | | | | |
| | | | | | | | Stress | | | | |
| | | | | | | | −27.2 to −31.5 | | | | |
| A7 | ULE Glass | Fe P | BS | Germanium Oxide | Fe P | BS | Magnesium | Fe P | BS | Fe P | BS |
| | Compressive | 16.3 | 18 | Silicate Glass | 1.6 | 1.8 | Aluminosilicate | 1.6 | 1.8 | −31.5 | −27.2 |
| | Stress −3.0 | | | Compressive Stress | | | Glass | | | | |
| | | | | −2.8 | | | Compressive | | | | |
| | | | | | | | Stress | | | | |
| | | | | | | | −27.2 to −31.5 | | | | |
| A3 | ULE Glass | Fe P | BS | Low Expansion | Fe P | BS | Magnesium | Fe P | BS | Fe P | BS |
| | Compressive | 11.4 | 18 | Glass Ceramic | 1.6 | 1.8 | Aluminosilicate | 1.6 | 1.8 | −31.5 | −27.2 |
| | Stress −1.5 | | | Compressive Stress | | | Glass | | | | |
| | | | | −4.4 | | | Compressive | | | | |
| | | | | | | | Stress | | | | |
| | | | | | | | −27.2 to −31.5 | | | | |
| B2 | Low Expansion | Fe P | BS | Fused Silica Glass | Fe P | BS | Magnesium | Fe P | BS | Fe P | BS |
| | Glass Ceramic | 13 | 13 | Compressive Stress | 1.6 | 1.8 | Aluminosilicate | 1.6 | 1.8 | −31.5 | −27.2 |
| | Compressive | | | −4.0 | | | Glass | | | | |
| | Stress −0.35 | | | | | | Compressive | | | | |
| | | | | | | | Stress | | | | |
| | | | | | | | −27.2 to −31.5 | | | | |
| B1 | ULE Glass | Fe P | BS | Fused Silica Glass | Fe P | BS | Magnesium | Fe P | BS | Fe P | BS |
| | Compressive | 12.4 | 12.4 | Compressive Stress | 1.6 | 1.8 | Aluminosilicate | 1.6 | 1.8 | −31.5 | −27.2 |
| | Stress −1.8 | | | −4.0 | | | Glass | | | | |
| | | | | | | | Compressive | | | | |
| | | | | | | | Stress | | | | |
| | | | | | | | −27.2 to −31.5 | | | | |
| C1 | Borosilicate | Fe P | | Medium | Fe P | | Soda Lime | Fe P | | Fe P | BS |
| | Glass | 4.3 | | Expansion | 7.1 | | Glass | 4.3 | | −5.9 | N.A. |
| | Compressive | | | Glass Ceramic | | | Compressive | | | | |
| | Stress −9.5 | | | Compressive Stress | | | Stress −5.9 | | | | |
| | | | | −11.7 | | | | | | | |
| C2 | Low Expansion | Fe P | BS | Medium | Fe P | BS | Special Soda | Fe P | BS | Fe P | BS |
| | Glass Ceramic | 3.8 | 3.8 | Expansion | 6.8 | 6.8 | Lime Glass | 4.9 | 4.9 | −7.3 | −3.0 |
| | Compressive | | | Glass Ceramic | | | Compressive | | | | |
| | Stress −18.3 | | | Compressive Stress | | | Stress | | | | |
| | | | | −10.3 | | | −3.0 to −7.3 | | | | |
| A1 | Fused Silica | Fe P | BS | Borosilicate Glass | Fe P | BS | Medium | Fe P | BS | Fe P | BS |
| | Glass | 5.3 | 5.3 | Compressive Stress | 8.8 | 5.3 | Expansion | 2.8 | 3.8 | −17.6 | −13.3 |
| | Compressive | | | −9.5 | | | Glass Ceramic | | | | |
| | Stress −8.5 | | | | | | Compressive | | | | |
| | | | | | | | Stress | | | | |
| | | | | | | | −13.3 to −17.6 | | | | |

TABLE 7
Estimated Stress performance of preferred embodiments with a three/four layer preferably all layer fused together
embodiments with Iron Phosphate (Fe P) and Borosilicate (BS) Waste Glass (WG)

| | | Tension | | | Tension | | Layer Three | |
|---|---|---|---|---|---|---|---|---|
| | Layer One | Ratio of Joint Min | | Layer Two | Ratio of Joint Min | | Vitrified Nuclear Waste | |
| | Compression M Pa | MOR/Max Stress | | Compression M Pa | MOR/Max Stress | | Compression M Pa | |
| A9 | Medium Expansion | Fe P | BS | Special Soda Lime Glass | Fe P | BS | Fe P WG | BS WG |
| | Glass Ceramic | 11.4 | 25 | Compressive Stress | 6.8 | 15 | −7.3 | −3.0 |
| | Compressive Stress −3.4 | | | −3.0 to −7.3 | | | | |
| A8 | Medium Expansion | Fe P | | Soda Lime Glass | Fe P | | Fe P WG | BS WG |
| | Glass Ceramic | 14.1 | | Compressive Stress | 8.5 | | −5.9 | N.A. |
| | Compressive Stress −4.8 | | | −5.9 | | | | |
| A1 | Fused Silica Glass | Fe P | BS | Borosilicate Glass | Fe P | BS | Fe P WG | BS WG |
| | Compressive Stress −8.2 | 6 | 6 | Compressive Stress | 6 | 2.2 | −27.3 | −23 |
| | | | | −23 to −27.3 | | | | |
| A2 | ULE Glass | Fe P | BS | Borosilicate Glass | Fe P | BS | Fe P WG | BS WG |
| | Compressive Stress −10.1 | 5 | 5 | Compressive Stress | 5 | 2.2 | −27.3 | −23 |
| | | | | −23 to −27.3 | | | | |
| C2 | Low Expansion | Fe P | BS | Medium Expansion | Fe P | BS | Fe P WG | BS WG |
| | Glass Ceramic | 3.8 | 3.8 | Glass Ceramic | 2.8 | 3.8 | −17.6 | −13.3 |
| | Compressive Stress −18.3 | | | Compressive Stress | | | | |
| | | | | −13.3 to −17.6 | | | | |
| C1 | Borosilicate Glass | Fe P | BS | Medium Expansion | Fe P | BS | Fe P WG | BS WG |
| | Compressive Stress −9.5 | 2.8 | 3.8 | Glass Ceramic | 2.8 | 3.8 | −17.6 | −13.3 |
| | | | | Compressive Stress | | | | |
| | | | | −13.3 to −17.6 | | | | |
| A10 | Borosilicate Glass | Fe P | | Soda Lime Glass | Fe P | | Fe P WG | BS WG |
| | Compressive Stress −21.2 | 2.4 | | Compressive Stress | 2.4 | | −5.9 | N.A. |
| | | | | −5.9 | | | | |
| B2 | Low Expansion | Fe P | BS | Fused Silica Glass | Fe P | BS | Fe P WG | BS WG |
| | Glass Ceramic | 1.5 | 1.7 | Compressive Stress | 1.4 | 1.6 | −35.5 | −31.2 |
| | Compressive Stress −0.35 | | | −31.2 to −35.5 | | | | |
| A5 | Fused Silica Glass | Fe P | BS | Germanium Oxide Silicate | Fe P | BS | Fe P WG | BS WG |
| | Compressive Stress −1.2 | 1.5 | 1.7 | Glass | 1.5 | 1.7 | −34.2 | −30 |
| | | | | Compressive Stress | | | | |
| | | | | −31.2 to −35.5 | | | | |
| A3 | ULE Glass | Fe P | BS | Low Expansion | Fe P | BS | Fe P WG | BS WG |
| | Compressive Stress −1.5 | 1.4 | 1.6 | Glass Ceramic | 1.4 | 1.6 | −35.9 | −31.5 |
| | | | | Compressive Stress | | | | |
| | | | | −31.5 to −35.9 | | | | |
| B1 | ULE Glass | Fe P | BS | Fused Silica Glass | Fe P | BS | Fe P WG | BS WG |
| | Compressive Stress −1.8 | 1.4 | 1.6 | Compressive Stress | 1.4 | 1.6 | −35.6 | −31.2 |
| | | | | −31.2 to −35.6 | | | | |
| A7 | ULE Glass | Fe P | BS | Germanium Oxide Silicate | Fe P | BS | Fe P WG | BS WG |
| | Compressive Stress −3.1 | 1.5 | 1.7 | Glass | 1.5 | 1.7 | −34.3 | −30 |
| | | | | Compressive Stress | | | | |
| | | | | −30 to −34.3 | | | | |
| A4 | Fused Silica Glass | Fe P | BS | Magnesium Aluminosilicate | Fe P | BS | Fe P WG | BS WG |
| | Compressive Stress −4.0 | 1.6 | 1.8 | Glass | 1.6 | 1.8 | −31.4 | −27.2 |
| | | | | Compressive Stress | | | | |
| | | | | −27.2 to −31.4 | | | | |
| A6 | ULE Glass | Fe P | BS | Magnesium Aluminosilicate | Fe P | BS | Fe P WG | BS WG |
| | Compressive Stress −5.8 | 1.6 | 1.8 | Glass | 1.6 | 1.8 | −31.4 | −27.2 |
| | | | | Compressive Stress | | | | |
| | | | | −27.2 to −31.3 | | | | |

TABLE 9
Estimated Stress performance of five embodiments with a four layer preferably one layer not fused together
embodiments where the Vitrified Nuclear Waste Glass is Iron Phosphate (Fe P) when the not fused layer is
Stainless Steel or Zirconium Metal

| | | Tension | | | | Tension M Pa | |
|---|---|---|---|---|---|---|---|
| | | M Pa | | | Layer Three | Joint is potentially | Layer Four |
| | Layer One | Ratio of Joint | Layer Two | No | Tension M Pa | cracked or failed at | Tension M Pa |
| | Compression | Min MOR/Max | Compression | Joint | Ratio of Layer MOR/Max | Layer Four | Ratio Tension to Layer |
| | M Pa | Stress | M Pa | Stress | Stress | interface | MOR |
| B2 | Low expansion | 149 | Fused silica | | 0.91 | Tension Stress | 1.1 X |
| | glass ceramic | | Compressive | | Stainless Steel | ≦+55 | Vitrified nuclear waste |
| | Compressive | | Stress −0.35 | | Tension Stress | | Tension |
| | Stress −0.35 | | | | +55 | | Stress ≦+55 |
| A5 | Fused silica | 41 | Germanium oxide | | 0.91 | Tension Stress | 1.1 X |
| | Compressive | | silicate glass | | Stainless Steel | ≦+55 | Vitrified nuclear waste |
| | Stress −1.2 | | Compressive | | Tension Stress | | Tension |
| | | | Stress −1.2 | | +55 | | Stress ≦+55 |
| A3 | ULE | 34 | Low expansion | | 0.91 | Tension Stress | 1.1 X |
| | Compressive | | glass ceramic | | Stainless Steel | ≦+55 | Vitrified nuclear waste |
| | Stress −1.5 | | Compressive | | Tension Stress | | Tension |
| | | | Stress −0.35 | | +55 | | Stress ≦+55 |
| B1 | ULE | 27 | Fused silica | | 0.91 | Tension Stress | 1.1 X |
| | Compressive | | Compressive | | Stainless Steel | ≦+55 | Vitrified nuclear waste |
| | Stress −1.8 | | Stress −1.8 | | Tension Stress | | Tension |
| | | | | | +55 | | Stress ≦+55 |
| B2 | Low expansion | 149 | Fused silica | | 24 | Tension Stress | .25 X |
| | glass ceramic | | Compressive | | Zirconium | ≦+12.5 | Vitrified nuclear waste |
| | Compressive | | Stress −0.35 | | Compressive | | Compressive |
| | Stress −0.35 | | | | Stress −12.5 | | Stress −12.5 |

TABLE 10
Estimated Stress performance of embodiments B2 where the Vitrified Nuclear Waste Glass is Iron Phosphate (Fe P) with a
four layer preferably one layer not fused together embodiments when the not fused layer (to layer two) is a Glass or Glass
Ceramic

| | | Tension | | | | Tension | |
|---|---|---|---|---|---|---|---|
| | | M Pa | | | | M Pa | |
| | Layer One | Ratio of Joint | Layer Two | No | Layer Three | Ratio of Joint | Layer Four |
| | Compression | Min MOR/Max | Compression | Joint | Compression | Min MOR/Max | Compression |
| | M Pa | Stress | M Pa | Stress | M Pa | Stress | M Pa |
| B2 | Low expansion | 149 | Fused silica | | Soda Lime Glass | 8.8 | Vitrified nuclear waste |
| | glass ceramic | | Compressive | | Compressive | | Compressive |
| | Compressive | | Stress −0.35 | | Stress −5.7 | | Stress −5.7 |
| | Stress −0.35 | | | | | | |
| B2 | Low expansion | 149 | Fused silica | | Special Soda Lime | 7.0 | Vitrified nuclear waste |
| | glass ceramic | | Compressive | | Glass | | Compressive |
| | Compressive | | Stress −0.35 | | Compressive | | Stress −7.1 |
| | Stress −0.35 | | | | Stress −7.1 | | |
| B2 | Low expansion | 149 | Fused silica | | Medium Expansion | 4.8 | Vitrified nuclear waste |
| | glass ceramic | | Compressive | | Glass Ceramic | | Compressive |
| | Compressive | | Stress −0.35 | | Compressive | | Stress −10.5 |
| | Stress −0.35 | | | | Stress −10.5 | | |
| B2 | Low expansion | 149 | Fused silica | | Fused Silica | 1.4 | Vitrified nuclear waste |
| | glass ceramic | | Compressive | | Compressive | | Compressive |
| | Compressive | | Stress −0.35 | | Stress −35.5 | | Stress −35.5 |
| | Stress −0.35 | | | | | | |
| A5 | Fused silica | 41 | Germanium oxide silicate | | Soda Lime Glass | 8.8 | Vitrified nuclear waste |
| | Compressive | | glass | | Compressive | | Compressive |
| | Stress −1.2 | | Compressive | | Stress −5.7 | | Stress −5.7 |
| | | | Stress −1.2 | | | | |
| A5 | Fused silica | 41 | Germanium oxide silicate | | Special Soda Lime | 7.0 | Vitrified nuclear waste |
| | Compressive | | glass | | Glass | | Compressive |
| | Stress −1.2 | | Compressive | | Compressive | | Stress −7.1 |
| | | | Stress −1.2 | | Stress −7.1 | | |
| A5 | Fused silica | 41 | Germanium oxide silicate | | Medium Expansion | 4.8 | Vitrified nuclear waste |
| | Compressive | | glass | | Glass Ceramic | | Compressive |
| | Stress −1.2 | | Compressive | | Compressive | | Stress −10.5 |
| | | | Stress −1.2 | | Stress −10.5 | | |
| A5 | Fused silica | 41 | Germanium oxide silicate | | Fused Silica | 1.4 | Vitrified nuclear waste |
| | Compressive | | glass | | Compressive | | Compressive |
| | Stress −1.2 | | Compressive | | Stress −35.5 | | Stress −35.5 |
| | | | Stress −1.2 | | | | |

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

1. A radioactive waste containment system for containing a radioactive waste material, said radioactive waste containment system including
a radioactive waste containment system outermost exterior containment layer comprised of an exterior containment layer glass material having an exterior containment layer property λE,
a radioactive waste containment system adjacent interior containment layer, said adjacent interior containment layer comprised of an adjacent interior containment layer glass material having an adjacent interior containment layer property λ,
said radioactive waste containment system adjacent interior containment layer fused with said radioactive waste containment system outermost exterior containment layer with λE≠λ wherein said fused adjacent interior containment layer and said radioactive waste containment system outermost exterior containment layer are in compression.

2. A radioactive waste containment system as claimed in claim 1 wherein said exterior containment layer property λE is a Coefficient of Thermal Expansion (CTE) of said exterior containment layer glass material, and said adjacent interior containment layer property λ is a Coefficient of Thermal Expansion (CTE) of said adjacent interior containment layer glass material with λE<λ.

3. A radioactive waste containment system as claimed in claim 2, said radioactive waste containment system including an innermost waste adjacent interior containment layer, said radioactive waste containment system innermost waste adjacent interior containment layer for containment of a radioactive waste material while said radioactive waste material is melted at a glass melting temperature.

4. A radioactive waste containment system as claimed in claim 2, said radioactive waste containment system including a containment system top lid, said containment system top lid comprised of a lid exterior containment layer and a lid adjacent interior containment layer.

5. A radioactive waste containment system as claimed in claim 4, said radioactive waste containment system outermost exterior containment layer includes a vertically oriented side wall, wherein said lid exterior containment layer is sealed to said vertically oriented side wall with a glass material.

6. A method of making a radioactive waste containment system for containing a radioactive waste material,
said method including the steps of:
providing an adjacent interior containment layer glass material having an adjacent interior containment layer property λ,
providing an outermost exterior containment layer glass material having an exterior containment layer property λE with λE≠λ,
and orienting said outermost exterior containment layer glass material relatively external of said adjacent interior containment layer glass material to provide for containment of a radioactive waste isolated from a surrounding exterior environment.

7. A method as claimed in claim 6, wherein said exterior containment layer property λE is a Coefficient of Thermal Expansion (CTE) of said exterior containment layer glass material, and said adjacent interior containment layer property λ is a Coefficient of Thermal Expansion (CTE) of said adjacent interior containment layer glass material with λE<λ.

8. A method as claimed in claim 7 wherein said exterior containment layer glass material and said adjacent interior containment layer glass material are fused together to provide a radioactive waste containment system outermost exterior containment layer and an adjacent interior containment layer, with said radioactive waste containment system outermost exterior containment layer and said adjacent interior containment layer in compression.

9. A method as claimed in claim 6, including providing an innermost waste adjacent interior containment layer.

10. A method as claimed in claim 9, including providing a melted radioactive waste glass material at a radioactive waste glass material melting temperature, and disposing said melted radioactive waste glass material adjacent said innermost waste adjacent interior containment layer.

11. A method as claimed in 10 including providing a containment system top lid, said containment system top lid comprised of a lid exterior containment layer and a lid adjacent interior containment layer.

12. A method as claimed in claim 11, wherein said outermost exterior containment layer includes a vertically oriented side wall, and said containment system top lid is disposed on top of said outermost exterior containment layer vertically oriented side wall.

13. A method as claimed in claim 12 including sealing said lid exterior containment layer to said outermost exterior containment layer vertically oriented side wall with a glass material.

14. A method of containing a radioactive waste, said method including:
providing a waste material,
providing a interior containment layer glass material having an interior containment layer Coefficient of Thermal Expansion (CTE) property λ,
providing an exterior containment layer glass material having an exterior containment layer property Coefficient of Thermal Expansion (CTE) property λE with λE<λ1
and orienting said exterior containment layer glass material relatively external of said interior containment layer glass material to provide an in compression interior containment layer and an in compression exterior containment layer wherein said waste material is isolated from a surrounding exterior environment by said in compression interior containment layer and said in compression exterior containment layer with said radioactive waste material proximate said in compression interior containment layer.

15. A method as claimed in claim 14 wherein said exterior containment layer glass material and said interior containment layer glass material are fused together.

16. A method as claimed in claim 15, wherein said waste material is disposed in contact with an innermost waste adjacent interior containment layer.

17. A method as claimed in claim 16, including providing a melted radioactive waste glass material at a radioactive waste glass material melting temperature, and disposing said melted radioactive waste glass material adjacent said innermost waste adjacent interior containment layer.

18. A method as claimed in 14 including providing a containment system top lid, said containment system top lid comprised of a lid exterior containment layer and a lid adjacent interior containment layer.

19. A method as claimed in claim 18, wherein said exterior containment layer includes a vertically oriented side wall, and said containment system top lid is disposed on top of said outermost exterior containment layer vertically oriented side wall.

20. A method as claimed in claim 19 including sealing said lid exterior containment layer to said outermost exterior containment layer vertically oriented side wall with a glass material.

21. A radioactive waste containment system, said radioactive waste containment system including a means for containing a radioactive waste material.

22. A system as claimed in claim 21 wherein said means for containing a radioactive waste material includes at least a first glass material layer in compression.

23. (canceled)

24. (canceled)
